(19) United States
(12) Patent Application Publication
(10) Pub. No.: US 2026/0201212 A1
(43) Pub. Date: Jul. 16, 2026

(54) PROCESS FOR FORMING AN AQUEOUS DISPERSION OF COPOLYMERS, AN ADHESIVE COMPOSITION INCLUDING SUCH COPOLYMERS, A FILM OR AN ARTICLE COMPRISING THE SAME, AND A METHOD OF COATING A SUBSTRATE

(71) Applicant: WACKER CHEMIE AG, Munich (DE)

(72) Inventors: Amitabha Mitra, Ann Arbor, MI (US); Christian HARTMAN, Grand Rapids, MI (US); Ryan HOLLINGSWORTH, Ann Arbor, MI (US)

(73) Assignee: WACKER CHEMIE AG, Munich (DE)

(21) Appl. No.: 19/127,917

(22) PCT Filed: Nov. 8, 2023
(86) PCT No.: PCT/EP2023/081223

§ 371 Date: May 8, 2025

Related U.S. Application Data
(60) Provisional application No. 63/423,947, filed on Nov. 9, 2022.

(51) Int. Cl. C09J 7/38

(52) U.S. Cl. CPC C09J 7/38; C09J 2301/302; C09J 2301/414

(57) ABSTRACT

A process for forming an aqueous dispersion of copolymers includes providing a copolymerizable composition in water. The copolymerizable composition includes 5 to 95% by weight of ethylenically functionalized silicone polymers or silanes, which is based on the total weight of the copolymerizable composition, and 5% or more by weight of organic acrylic monomers, which is based on the total weight of the copolymerizable composition. The process also comprises providing 0.1 to 10 wt % of a surfactant, which is based on the total weight of the ethylenically functionalized silicone polymers or silanes and organic acrylic monomers. The ethylenically functionalized silicone polymers or silanes and the organic acrylic monomers are polymerized to form an aqueous dispersion of copolymers. The copolymers exhibit a glass transition temperature (Tg) of 0 to −100° C. The Tg is determined by differential scanning calorimetry with a heating rate of 10° K per minute according to DIN 53765, pierced crucible.

### BACKGROUND

The invention relates to aqueous dispersions of copolymers, the adhesives including such copolymers, and methods of coating substrates with such materials.

Adhesives such as a pressure sensitive adhesive (PSA) will bond to a substrate when pressure is applied to marry the adhesive with the substrate.

Traditional PSAs have included organic solvents. More recently, due to environmental, resource-saving, and safety concerns, PSAs have utilized water as the solvent.

Water-based PSAs predominantly have included dispersions of acrylic polymers or copolymers. The advantages of acrylic PSAs include the ability to control glass transition temperature (Tg), molecular architecture, crosslinking density, and competitive cost of such systems. PSAs with excellent tack and peel strength are achievable by incorporating acrylics and such PSAs have good environmental stability and resistance to oxidation.

However, a disadvantage of an acrylic PSA is the difficulty encountered during bonding to low surface energy surfaces such as those containing, for example, silicone, polyethylene, or polypropylene. Also, acrylic PSAs cause adhesion build up on the surfaces they are applied to over time and can be challenging to cleanly remove from the surface. Furthermore, when utilized in an on-skin application, acrylic PSAs can cause skin trauma during removal from the skin and have limited repositionability.

PSAs that include acrylate systems suffer from the same disadvantages and also typically have poor high and low temperature performance.

Therefore, it would be desirable to provide materials that could be utilized in an adhesive and enable the adhesive to overcome the above-described deficiencies. A process for forming such materials would also be desirable along with the ancillary embodiments thereof.

### BRIEF SUMMARY

Embodiments of a process for forming an aqueous dispersion of copolymers are provided. In an embodiment, the process comprises providing a copolymerizable composition in water. The copolymerizable composition includes 5 to 95% by weight of ethylenically functionalized silicone polymers or silanes, which is based on the total weight of the copolymerizable composition. The copolymerizable composition also includes 5% or more by weight of organic acrylic monomers, which is based on the total weight of the copolymerizable composition. The process comprises providing 0.1 to 10 wt % of a surfactant, which is based on the total weight of the ethylenically functionalized silicone polymers or silanes and organic acrylic monomers. The ethylenically functionalized silicone polymers or silanes and the organic acrylic monomers are polymerized to form an aqueous dispersion of copolymers. The copolymers exhibit a glass transition temperature (Tg) of 0 to −100° C. The Tg being determined by differential scanning calorimetry with a heating rate of 10° K per minute according to DIN 53765, pierced crucible.

In certain embodiments, the process further comprises forming a miniemulsion. The miniemulsion comprises the ethylenically functionalized silicone polymers or silanes, organic acrylic monomers, and surfactant. A radical initiator is also introduced. The organic acrylic monomers comprise one or more acrylates or acrylic acid monomers. The ethylenically functionalized silicone polymers or silanes and the organic acrylic monomers are polymerized in the presence of the surfactant and water.

In some embodiments, the miniemulsion comprises organic droplets. The organic droplets comprise the ethylenically functionalized silicone polymers or silanes and the organic acrylic monomers and are formed prior to polymerizing the ethylenically functionalized silicone polymers or silanes and the organic acrylic monomers.

In other embodiments, the process further comprises curing the aqueous dispersion of copolymers by heating the aqueous dispersion to evaporate the water therefrom.

Preferably, the aqueous dispersion of copolymers comprises a solids content of 40 wt % or more, based on the total weight of the aqueous dispersion. More preferably, the solids content of the aqueous dispersion of copolymers is 40 to 70 wt %, based on the total weight of the aqueous dispersion.

In some embodiments, the copolymers exhibit a Tg of −10 to −60° C. In other embodiments, the copolymers have a z-average particle size of 1000 nanometers or less when measured by a dynamic light scattering method.

In an embodiment, the aqueous dispersion of copolymers exhibits a viscosity of 1 to 20,000 mPa·s at 25° C.

In other embodiments, an adhesive composition is provided. In an embodiment, the adhesive composition comprises the copolymers formed by the process for forming an aqueous dispersion of copolymers.

In some embodiments, a film of the adhesive composition has a 381 microns wet thickness and exhibits a peak tack of 100 grams of force or more after curing when measured by a TA.XT Plus Texture Analyzer using a TA-57R probe and a TA-303 apparatus. Preferably, the film exhibits a peak tack of 100 to 1,000 grams of force.

In other embodiments, the adhesive composition comprises an active compound that can be released at a controlled rate from a matrix formed by the copolymers. In still other embodiments, the adhesive composition is stable against layer separation at 25° C. as measured by the absence of any observable phase separation for 180 days.

Preferably, the adhesive composition has volatile organic content of 2.5% or less according to EP A test method 24. In certain embodiments, the adhesive composition is stable against layer separation at 25° C. as measured by the absence of variation in z-average particle size by more than 20%. In other embodiments, the adhesive composition is a pressure sensitive adhesive.

In still other embodiments, a film comprising the adhesive composition is provided. The film does not exhibit a residue transfer upon contact.

Embodiments of an article are also provided. In an embodiment, the article comprises the adhesive composition on a substrate. The adhesive composition forms a film. The film has a 381 microns wet thickness and, after curing at 60° C. for 15 minutes, attaching a stainless steel plate to an outer surface of the film, resting for 30 minutes and then removing the stainless plate at a rate of 300 mm/min (12 in/min), the film exhibits a 180 degree peel strength of 1.5 N/inch or more as measured by an adhesion/release tester at a rate of 12 in/min.

Embodiments of a method of coating a substrate are also provided. In an embodiment, the method comprises applying the adhesive composition to a substrate and curing the composition. In some embodiments, the adhesive composition is applied by spraying, knife coating, roller coating, casting, drum coating, dipping and combinations thereof or by a transfer-coating method.

### BRIEF DESCRIPTION OF THE SEVERAL VIEWS OF THE DRAWINGS

The above, as well as other advantages of the present invention will become readily apparent to those skilled in the art from the following detailed description when considered in the light of the accompanying drawings in which:

FIG. 1 is a release profile illustrating release of an active from an adhesive composition in accordance with the invention over time; and

FIG. 2 is a release profile illustrating release of an active from an adhesive composition in accordance with the invention over time.

### DETAILED DESCRIPTION OF THE PREFERRED EMBODIMENTS

It is to be understood that the invention may assume various alternative orientations and step sequences, except where expressly specified to the contrary. It is also to be understood that the specific processes, compositions, articles, and methods described in the following specification are simply exemplary embodiments of the inventive concepts. Hence, specific properties, conditions, or other physical characteristics relating to the embodiments disclosed are not to be considered as limiting, unless expressly stated otherwise.

Further, as used herein, the terms “comprises,” “comprising,” “includes,” “including,” “has,” “having” or any other variation thereof, are intended to cover a non-exclusive inclusion. For example, a method, article, or composition that comprises a list of features is not necessarily limited only to those features but may include other features not expressly listed or inherent to such method, article, or composition. Further, unless expressly stated to the contrary, “or” refers to an inclusive- or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

In certain embodiments, a process for forming an aqueous dispersion of copolymers is provided. The copolymers are suitable for use in an adhesive composition. For example, the copolymers may be utilized in a pressure sensitive adhesive. Such adhesives exhibit good tack, adhesion, and shear resistance properties and may be used in on-skin and/or medical applications in such items like surgical tapes, dressings, drapes, bandages, and wearable devices. However, the adhesive composition is not limited to medical applications and can be utilized in other applications where a tacky, cohesive, and low trauma adhesive is desired. For example, the adhesive composition may be utilized in non-medical wearable device applications such as, for example, headset devices or in other applications such as, for example, industrial tapes, surface protection films for electronics, other instruments, and automotive components.

In an embodiment, the process for forming an aqueous dispersion of copolymers comprises providing a copolymerizable composition in water. The copolymerizable composition includes 5 to 95% by weight of ethylenically functionalized silicone polymers or silanes, which is based on the total weight of the copolymerizable compounds and 5% or more by weight of organic acrylic monomers, which is based on the total weight of the copolymerizable compounds. A surfactant is provided at 0.1 to 10 wt %, which is based on the total weight of the ethylenically functionalized silicone polymers or silanes and organic acrylic monomers. The ethylenically functionalized silicone polymers or silanes and the organic acrylic monomers are polymerized to form an aqueous dispersion of copolymers. The copolymers exhibit a glass transition temperature (Tg) of 0 to −100° C., the Tg is determined by differential scanning calorimetry with a heating rate of 10° K per minute according to DIN 53765, pierced crucible.

In some embodiments, the weight ratio between the ethylenically functionalized silicone polymers or silanes and the ethylenically unsaturated organic acrylic monomers can vary between 0.05 to 99.

Organic acrylic monomers suitable for use in the copolymerizable composition are acrylic or methacrylic acids and esters. Suitable monomers form the group of acrylic esters or methacrylic esters are esters of unbranched or branched alcohols having 1 to 20 carbon atoms. Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, tert-butyl acrylate, tert-butyl methacrylate, 2-ethylhexyl acrylate, stearyl acrylate, phenyl acrylate and norbornyl acrylate. Particularly preferred are methyl acrylate, methyl methacrylate, n-butyl acrylate, n-butyl methacrylate isobutyl acrylate, tert-butyl acrylate, 2-ethylhexyl acrylate, stearyl acrylate and norbornyl acrylate. Preferably, the organic acrylic monomers comprise one or more acrylate, methacrylic acid or acrylic acid monomers. In some embodiments, it may be preferred that the organic acrylic monomers comprise a combination of one or more acrylates, one or more methacrylic acid, and/or one or more acrylic acid monomers.

Additional monomers are also suitable to be included in the copolymerizable composition. In some embodiments, such monomers are ethylenically unsaturated monomers including vinyl esters, preferably those of carboxylic acids having 1 to 15 carbon atoms. Preferred are vinyl acetate, vinyl propionate, vinyl butyrate, vinyl 2-ethylhexanoate, vinyl laurate, 1-methylvinyl acetate, vinyl pivalate and vinyl esters of alpha-branched monocarboxylic acids having 9 to 11 carbon atoms, as for example VeoVa9® or VeoVa10® (trade names of Resolution). Particularly preferred is vinyl acetate.

Additional monomers may also include vinylaromatics, vinyl halogen compounds, vinyl ethers, and olefins. Preferred vinylaromatics are styrene, alpha-methylstyrene, the isomeric vinyltoluenes and vinylxylenes, and also divinylbenzenes. Particularly preferred is styrene. Preferred vinyl halogen compounds include vinyl chloride, vinylidene chloride, and also tetrafluoroethylene, difluoroethylene, hexylperfluoroethylene, 3,3,3-trifluoropropene, perfluoropropyl vinyl ether, hexafluoropropylene, chlorotrifluoroethylene, and vinyl fluoride. Particularly preferred is vinyl chloride. An example of a preferred vinyl ether is methyl vinyl ether. The preferred olefins are ethene, propene, 1-alkylethenes, and also polyunsaturated alkenes, and the preferred dienes are 1,3-10 butadiene and isoprene. Particularly preferred are ethene and 1,3-butadiene.

Optionally it is further possible for 0.1 to 5 wt % of auxiliary monomers to be copolymerized, based on the total weight of the copolymerizable components. Preference is given to using 0.5 to 2.5 wt % of auxiliary monomers. Examples of auxiliary monomers fumaric acid, and maleic acid; ethylenically unsaturated carboxamides and carbonitriles, preferably acrylamide such as N-methyl acrylamide, N, N-dimethyl acrylamide, t-octyl acrylamide, diacetoneacrylamide (DAAM) and acrylonitrile; monoesters and diesters of fumaric acid and maleic acid such as the diethyl and diisopropyl esters and also maleic anhydride, ethylenically unsaturated sulfonic acids and their salts, preferably vinylsulfonic acid, 2-acrylamido-2-methylpropanesulfonic acid. Further examples are precrosslinking comonomers such as polyethylenically unsaturated comonomers, examples being divinyl adipate, diallyl maleate, allyl methacrylate or triallyl cyanurate, or postcrosslinking comonomers, examples being acrylamidoglycolic acid (AGA), methylacrylamidoglycolic acid methyl ester (MAGME), N-methylolacrylamide (NMA), N-methylolmethacrylamide, N-methylolallylcarbamate, alkyl ethers such as the isobutoxy ether or esters of N-methylolacrylamide, of N-methylolmethacrylamide and of N-methylolallylcarbamate. Also suitable are vinyl amides having 1 to about 8 carbon atoms including vinyl pyrrolidone, and the like. Also suitable are comonomers with epoxide functionality such as glycidyl methacrylate and glycidyl acrylate. Mention may also be made of monomers having hydroxyl or CO groups, examples being hydroxyalkyl esters of acrylic and methacrylic acid, such as hydroxyethyl, hydroxypropyl or hydroxybutyl acrylate or methacrylate, and also compounds such as diacetoneacrylamide and acetylacetoxyethyl acrylate or methacrylate.

Particularly preferred as comonomers are one or more monomers from the group of vinyl acetate, vinyl esters of α-branched monocarboxylic acids having 9 to 11 carbon atoms, vinyl chloride, ethylene, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, styrene, and 1,3-butadiene. Also particularly preferred as comonomers are mixtures of vinyl acetate and ethylene; mixtures of vinyl acetate, ethylene, and a vinyl ester of α-branched monocarboxylic acids having 9 to 11 carbon atoms; mixtures of n-butyl acrylate and 2-ethylhexyl acrylate and/or methyl methacrylate; mixtures of styrene and one or more monomers from the group of methyl acrylate, ethyl acrylate, propyl acrylate, n-butyl acrylate, 2-ethylhexyl acrylate; mixtures of vinyl acetate and one or more monomers from the group of methyl acrylate, ethyl acrylate, propyl acrylate, n-butyl acrylate, 2-ethylhexyl acrylate, and optionally ethylene; and mixtures of 1,3-butadiene and styrene and/or methyl methacrylate; the stated mixtures may optionally further include one or more of the aforementioned auxiliary monomers.

In certain embodiments, the organic acrylic monomers may comprise a combination of acrylic monomers. One preferred combination of organic acrylic monomers includes soft monomers and hard monomers. As used herein, a “soft monomer” refers to a monomer which when homopolymerized will have a glass transition temperature of less than 0° C. Exemplary acrylic soft monomers include alkyl acrylates, such as butyl acrylate, propyl acrylate, 2-ethylhexyl acrylate, isooctyl acrylate, isodecyl acrylate, and the like. Other soft monomers such as the dialkyl fumarates may also be present. As used herein, a “hard monomer” refers to a monomer which if homopolymerized would have glass transition temperature above 0° C. Preferred hard monomers include methyl acrylate, ethyl acrylate, alkyl methacrylates, such as methyl methacrylate, ethyl methacrylate, butyl methacrylate, vinyl acetate and the like, which serve to modify adhesive properties. Hard monomers can also be one or more unsaturated carboxylic acids containing from 3 to about 5, preferably 3 to about 4, carbon atoms, such as acrylic acid, methacrylic acid, itaconic acid, fumaric acid and the like. These monomers serve to improve the cohesive strength and promote adhesion of the resulting adhesive composition.

The copolymerizable composition comprises at least one ethylenically functionalized silicone polymer or silane. The use of a silicone polymer or silane in forming the copolymers improves certain properties, such as water resistance, skin friendliness, breathability, and thermal resistance, when, for example, the copolymers are used in an adhesive.

The silicone polymer is, preferably silicone resin, which is functionalized with ethylenically unsaturated, radically polymerizable groups and consists of siloxane units of the general formula [R¹ₚ(OR²)_{z}SiO_{(4-p-z)/2}] (I),
where R¹ is identical or different at each occurrence and is a radical R* or E, where R* is identical or different at each occurrence and is a hydrogen atom or is a hydrocarbon radical which is free from aliphatic multiple C—C bonds, has 1 to 18 carbon atoms, preferably a C1-C18 alkyl, C6-C18 cycloalkyl or C6-C18 aryl radical, and may optionally be substituted, and E is an ethylenically unsaturated radical of the formula —(CR⁵₂)ₘ—X, preferably —(CH₂)₃—X, where m is an integer from 1 to 10, preferably 3, R² is identical or different at each occurrence and is a hydrogen atom or a hydrocarbon radical having 1 to 18 carbon atoms, preferably a C1-C18 alkyl or C6-C18 cycloalkyl radical, R⁵ is a hydrogen atom, a C1-C12 alkyl radical or a C6-C18 aryl radical, preferably a hydrogen atom, and X is an ethylenically unsaturated organic group, and R1 is an ethylenically unsaturated radical E in at least 1 mol % and at most 50 mol % of all siloxane units (I),
p is 0, 1, 2 or 3, and
z is 0, 1, 2 or 3, 15
where the sum p+z has a value of 0, 1, 2 or 3,
with the proviso that for at least 20 mol % of all siloxane units of the formula (I) in the silicone polymer, the sum p+z is 1 or 0, with p being 1 or 0 and z being 0.

The polymerizable silanes include vinyltrimethoxysilane, vinyltriethoxysilane, vinyltripropoxysilane, vinylmethyldimethoxysilane, vinylmethyldiethoxy-silane, vinylmethyldipropoxysilane, γ-methacryloxypropyltrimethoxysilane, γ-methacryloxypropyltrlethoxysilane, γ-methacryloxypropyl-tripropoxysilane, γ-methacryloxydimethoxysilane, γ-methacryloxypropyl-methyldimethoxysilane, γ-methacryloxypropylmethyldiethoxysilane, γ-methacryl-oxypropylmethyldipropoxysilane, γ-methacryloxymethyl-dimethoxysilane, γ-methacryloxymethyltrimethoxysilane, γ-methacryloxymethyl-trlethoxy-silane, (methacryloxymethyl)methyldimethoxysilane, (methacry-loxymethyl)-methyldiethoxysilane, γ-methacryloxypropyltriacetoxysilane, γ-acryloxypropyltrlmethoxy-silane, γ-acryloxypropyltriethoxy-silane, γ-methacryloxymethyldiethoxysilane, γ-acryloxypropyltripropoxysilane, γ-acryloxypropyl-methyldimethoxysilane, γ-acryloxypropylmethyldiethoxysilane, acryloxypropylmethyldipropoxysilane, methacryloxypropyltris(trimethylsiloxysilane) and the like.

Preferably, the silane is methacryloxypropyltris(trimethylsiloxysilane).

The process includes providing a surfactant. Preferably, the surfactant is provided at 0.1 to 10 wt %, which in each case is based on the total weight of the ethylenically functionalized silicone polymers or silanes and organic acrylic monomers. In some embodiments, the surfactant is an emulsifier. In an embodiment, the surfactant is a polymerizable surfactant, which may also be called reactive surfactant or copolymerizable surfactant. These surfactants are preferred when the copolymers are planned for use in a waterborne medical adhesive with no or minimum surfactant leaching. Suitable embodiments of the surfactant include allyl or vinyl substituted alkylphenolethoxylates and their sulfates, block copolymers of polyethylene oxide, propylene oxide or butylene oxide with polymerizable end groups, allyl or vinyl substituted ethoxylated alcohols and their sulfates, maleate half esters of fatty alcohols, monoethanolamide ethoxylates of unsaturated fatty acids capable of undergoing autoxidative polymerization, allyl or vinyl polyalkylene glycol ethers, alkyl polyalkylene glycolether sulfates, functionalized monomer and surfactants, and combinations thereof. Examples of polymerizable surfactants include those sold under the trade name of HITENOL such as the HITENOL AR series and the HITENOL KH series, which are commercially available from Montello Inc.

As mentioned above, it is possible to use a combination of organic acrylic monomers in the process. For example, the organic acrylic monomers may comprise one or more acrylates and acrylic acid monomers. In one such embodiment, the copolymerizable composition includes 67 wt % methacryloxypropyltris(trimethylsiloxysilane, 19 wt % 2-ethylhexylacrylate, 6.6 wt % methylacrylate, 2.8 wt % acrylic acid with 4.6 wt % of a polymerizable surfactant, based on the total weight of the copolymerizable composition. In this embodiment, the polymerizable surfactant can be, for example, HITENOL KH-10.

In certain embodiments, the aqueous dispersion of copolymers may be prepared in a heterophase process. In one embodiment, the heterophase process is a miniemulsion polymerization. In such an embodiment, the miniemulsion may be radically initiated and include the polymerization of the ethylenically functionalized silicone polymers or silanes and 5% or more by weight of organic acrylic monomers.

As understood by those skilled in the art, a miniemulsion polymerization differs from emulsion polymerization on a number of features. For example, in contrast to emulsion polymerization, where the size of the polymer latex particles is determined essentially by kinetic processes and the stability of the lattices, the basis for miniemulsion polymerization is that the monomers are present completely within micelles before the polymerization. Therefore, in a miniemulsion polymerization, less time is needed because the monomers do not require additional time to diffuse from a monomer droplets into the micelles during the polymerization. In other words, the copolymer particles formed may be regarded as polymerized copies of the micelles or organic droplets present at the start of polymerization. A consequence of this is that the size of the copolymer particles is determined exclusively by the dispersion process and by the stability of the micelles. Since there is no need for transport of the monomers, e.g. the ethylenically functionalized silicone polymers, silanes, or the organic acrylic monomers, through the continuous phase, it is possible in this way to enable the use of monomers which are absolutely insoluble in the continuous phase. To increase the stability of the organic droplets it is necessary to suppress Ostwald ripening that may occur. During the miniemulsion polymerization, a hydrophobe or, in the case of inverse miniemulsions, a lipophobe is added. Among the species which may act as a hydrophobe, optionally, is a hydrophobic monomer suitable for the purpose, such as, for example, a silicon-containing component. In one such embodiment, the silicon-containing component is the ethylenically functionalized silicone polymers or silanes.

The miniemulsion polymerization differs here from suspension polymerization in that the resulting copolymer particles are much smaller (50 to 500 nm) than those of the suspension polymerization (1 μm to 1 mm) and the number of radicals per growing copolymer particle in the suspension polymerization, at 10, is well above those of the miniemulsion polymerization, where, viewed statistically, there is 0.5 radical per growing particle during the reaction.

In order to carry out a radical miniemulsion polymerization it is first of all necessary to construct a miniemulsion of a vinyl monomer in a continuous phase which is not miscible with said monomer. In certain embodiments, the vinyl monomer may be an organic acrylic monomer. For this purpose, the monomer, together with the emulsifier and the hydrophobe, is dispersed in water by input of energy, using, for example, a high-pressure homogenizer or by means of ultrasound. In certain embodiments, the combination of an emulsifier and hydrophobe retards the occurrence of Ostwald ripening and the coalescence of the organic droplets. In the second stage, the organic droplets formed in this way are polymerized. This may be triggered either by a water-soluble initiator, which is added after preparation of the stable miniemulsion, or by oil-soluble initiators, which may be present in the monomer phase right from the start, or by a combination of both.

In certain embodiments, the organic droplets formed in the miniemulsion have, approximately, a size of 50 to 500 nm. As used herein and for certain embodiments, organic droplets formed in the miniemulsion may also be referred to herein as particles. The size of the organic droplets is a consequence of the homogenization of the miniemulsion, achieved through the input of high quantities of energy. Preferably, the transfer of monomers between the individual organic droplets is suppressed by the specific type of stabilization.

Also, parallel to forming the small organic droplets, there are no longer any free micelles present in the miniemulsion. In contrast to the conventional emulsion polymerization, therefore, it is primarily the droplets which are the locus of nucleation (droplet nucleation). During the miniemulsion polymerization, accordingly, there is also only slight diffusion of the monomers observed. Within a miniemulsion polymerization, consequently, each dispersed organic droplet may be described as an individual reactor operated at a nanoscopic level. As a consequence, a number of advantages result from using a miniemulsion polymerization in the process for forming the aqueous dispersion of copolymers, in contrast to the traditional emulsion and suspension polymerizations, and these advantages are mentioned below.

For instance, because the monomers do not have to be transported through the continuous, usually aqueous phase, it is possible in the process to polymerize even monomers that are absolutely insoluble in water. Additionally, the size of the copolymer particles may correspond to that of the organic droplets formed beforehand, and can be adjusted with considerable precision via the nature and amount of the emulsifier used. Further, each organic droplet is homogeneous in its composition. Specifically, for copolymerization, therefore, the monomer ratio in each droplet is the same and is not subject to a difference in diffusion of the monomers. Also, the amounts of emulsifier used are smaller, since the miniemulsion is stabilized only kinetically, but not thermodynamically.

To prepare a miniemulsion used to form an aqueous dispersion of copolymers, the following steps are performed:

In a first step, ethylenically functionalized silicone polymers or silanes are dissolved in one or more of the organic acrylic monomers described herein, which forms a silicone or silane in-monomer solution. It should be noted that the silicone polymers or silanes are soluble in the respective organic acrylic monomers. In certain embodiments, insoluble constituents are separated off, as and when appropriate, by filtration. Preferably, the silicone or silane in-monomer solutions exhibit viscosities of 2 to 20,000 mPa·s at 25° C., preferably of 5 to 15,000 mPa·s at 25° C., more particularly of 7 to 10,000 mPa·s at 25° C.

The silicone or silane in-monomer solution is optionally admixed with a hydrophobic coemulsifier. Examples of hydrophobic coemulsifiers are known in the art and are suitable in forming the aqueous dispersion of copolymers.

In a second step, the silicone or silane in-monomer solution is emulsified with water and at least one surfactant, and optionally with auxiliaries, such as polymerization inhibitors which prevent the premature radical emulsion polymerization, in such a way, preferably with application of high shearing force as to obtain an emulsion that has droplet sizes of 350 nm or less, which are known as miniemulsions. High shearing force in this context may be generated by means of suitable emulsifying equipment, such as conventional rotor-stator systems, or in other ways that are known in the art such as, for example, by high-pressure homogenizers, dissolver disks, ultrasound devices or comparable emulsifying technologies allowing a high shearing force to be exerted that permits the generation of small particles of not more than 200 nm, forming miniemulsions having droplet sizes of not more than 350 nm. When using a commercial rotor-stator systems, rotary speeds of 4000 to 12,000 rpm, preferably of 5000 to 11,000 rpm, more particularly of 6000 to 10,000 rpm, have proven to be particularly advantageous. Both continuous and discontinuous embodiments are suitable. When using a high-pressure homogenizer, pressures of preferably 300 bar to 1000 bar, more preferably of 350 bar to 900 bar, more particularly of 400 bar to 800 bar, have proven to be advantageous. Since the preparations are polymerizable, implementing an effective temperature monitoring strategy is preferred. In some embodiments, it is preferred that the temperatures of the miniemulsions do not exceed 60° C., preferably 55° C., and more preferably 50° C. In embodiments where the temperature of the miniemulsion does not exceeds 50 to 60° C., the process may include cooling the miniemulsion rapidly below the aforementioned temperatures.

The miniemulsion comprises a continuous water phase and a dispersed organic phase. The amount of water in the miniemulsion is 20 to 80 weight percent (wt %), preferably 20 to 75, more particularly 25 to 70 wt %, in each case based on the total weight of the miniemulsion. Further, the miniemulsions of the invention possess viscosities of 2 to 5000 mPa·s at 25° C., particularly of 3 to 4500 mPa·s at 25° C., more particularly of 5 to 4000 mPa·s at 25° C. Viscosities in the above-described ranges are desirable because of the processing advantages and ease of handling.

The organic phase of the miniemulsion is polymerized by the process of radical emulsion polymerization. In this case, in a third step, the dispersed organic droplets are subjected to free radical polymerization. This radical emulsion polymerization is preferably executed by metered addition of the miniemulsion to an initial charge comprising water and a portion of catalyst. Further metered feeds may comprise the polymerization initiator, which may optionally encompass a plurality of components, each of which is separately metered in or included in the initial charge, according to their mutual interaction and function in the polymerization procedure. Metering of the feeds can be performed using commercially available equipment like a metering pump or an addition funnel.

The polymerization is initiated by water-soluble initiators or redox-initiator combinations, preferably with the latter. Examples of initiators are the sodium, potassium, and ammonium salts of peroxodisulfuric acid, hydrogen peroxide, tert-butyl peroxide, tert-butyl hydroperoxide, potassium peroxodiphosphate, tert-butyl peroxopivalate, cumene hydroperoxide, isopropylbenzene monohydroperoxide, and azobisisobutyronitrile. The stated initiators are used preferably in amounts of 0.01 to 4.0 wt %, based on the total weight of the monomers. As redox-initiator combinations, initiators identified above are used in conjunction with a reducing agent. Suitable reducing agents are sulfites and bisulfites of monovalent cations, an example being sodium sulfite, or the derivatives of sulfoxylic acid such as zinc or alkali metal formaldehydesulfoxylates, as for example sodium hydroxymethanesulfinate, and ascorbic acid. One class of preferred reducing agents are sulfinic acid compounds such as 2-hydroxy-2-sulfinato-acetic acid-disodium salt. Reducing agents of this preferred type are sold, for example, under the tradename Bruggolite® FF6 and Bruggolite® FF6 M. The amount of reducing agent is preferably 0.15 to 3 wt % of the monomer amount used. Additionally, small amounts of a metal compound which is soluble in the polymerization medium and whose metal component is redox-active under the polymerization conditions may be introduced, this compound being based for example on iron or vanadium. One particularly preferred initiator system comprising the aforementioned components is the system tert-butyl hydroperoxide/sodium hydroxymethanesulfinate/Fe(EDTA)^{2+/3+}.

It is also possible to use predominantly oil-soluble initiators, such as cumene hydroperoxide, isopropylbenzene monohydroperoxide, dibenzoyl peroxide or azobisisobutyronitrile. Preferred initiators for miniemulsion polymerizations are potassium persulfate, ammonium persulfate, azobisisobutyronitrile, and dibenzoyl peroxide.

After forming a miniemulsion comprising the ethylenically functionalized silicone polymers or silanes, organic acrylic monomers, and surfactant, the intiator is introduced as mentioned above.

After addition of the initiator, the ethylenically functionalized silicone polymers or silanes and the organic acrylic monomers are polymerized to form an aqueous dispersion of copolymers. Thus, the ethylenically functionalized silicone polymers or silanes and the organic acrylic monomers are polymerized in the presence of the surfactant and water. The polymerization may be carried out batchwise or continuously, with the inclusion of all or individual constituents of the reaction mixture in the initial charge, with individual constituents of the reaction mixture being included part in the initial charge and part metered in subsequently, or by the metering method without an initial charge. All metered feeds are made preferably at the rate at which the component in question is consumed. The polymerization may be conducted at a predetermined temperature. In certain embodiments, the reaction temperatures in the miniemulsion polymerization are 0° C. to 100° C. More preferably, the reaction temperatures in the miniemulsion polymerization are 5° C. to 80° C., and, in some embodiments, the reaction temperatures are 30° C. to 70° C.

When miniemulsion polymerization has been completed, the resulting aqueous dispersion of copolymers, where necessary, is adjusted for the desired pH, optionally filtered, and is then available for the respective use. In certain embodiments, the pH of the dispersing medium is between 2 and 9, preferably between 4 and 8. In a preferred embodiment, the pH is between 4.5 and 7.5. The pH can be adjusted before the start of the reaction by means of adding hydrochloric acid or aqueous sodium hydroxide solution to the dispersing medium.

Advantageously, the process forms an aqueous dispersion of copolymers that has a high solids content. For example, the aqueous dispersion of copolymers may comprise 40 or more wt % solids, based on the total weight of the aqueous dispersion. In some embodiments, the aqueous dispersion of copolymers comprises 40 to 70 wt % solids, based on the total weight of the aqueous dispersion. Preferably, the aqueous dispersion of copolymers comprises 40 to 65 wt % solids, based on the total weight of the aqueous dispersion.

In some embodiments, the aqueous dispersion of copolymers exhibits a viscosity of 1 to 20,000 mPa·s at 25° C. Preferably, the aqueous dispersion of copolymers exhibits a viscosity of 1 to 5,000 mPa·s at 25° C. The viscosities reported herein for the aqueous dispersion of copolymers, in each case, are for 25° C. and atmospheric pressure of 1013 mbar and can be determined by measurement using rotational viscometry in accordance with DIN EN ISO 3219 by using a Brookfield viscometer [spindle LV 1, 10 rpm].

Further, the copolymers formed by the polymerization may exhibit certain advantageous properties.

For example, the copolymers exhibit a desirable glass transition temperature (Tg) that makes them suitable for use in certain applications. The Tg of the copolymers can be preselected by selection of the monomers and/or the selection of the weight fractions of the monomers. In an embodiment, the copolymers exhibit a Tg of 0 to −100° C. In another embodiment, the copolymers exhibit a Tg of −10 to −60° C. In these embodiments, the Tg is determined by differential scanning calorimetry with a heating rate of 10° K per minute according to DIN 53765, pierced crucible. The Tg of the polymers can be determined in a known way by means of differential scanning calorimetry (DSC) according to DIN 53765, pierced crucible, heating at 10K/min. The Tg may also be calculated approximately in advance using the Fox equation. According to Fox T. G., Bull. Am. Physics Soc. 1, 3, page 123 (1956): 1/Tg=x₁/Tg₁+x₂/Tg₂+ . . . +xₙ/Tgₙ, where xₙ is the mass fraction (wt %/100) of the monomer n, and Tgₙ is the glass transition temperature in kelvins of the homopolymer of the monomer n. Tg values for homopolymers can be found in numerous literature references and standard works of polymer technology, and in tabular works which can be searched on the Internet, such as, for instance, from Aldrich under the entry “Polymer Properties, Thermal Transitions of Homopolymers” (https://www.sigmaaldrich.com/content/dam/sigma-10aldrich/docs/Aldrich/General_Information/thermal_transitions_of_homopolymers.pdf). Having a Tg in the ranges mentioned above means that the copolymer is pliable but not overly viscous.

The tack exhibited by an adhesive composition is a function of, inter alia, the Tg exhibited by the copolymers. Thus, the tack exhibited by an adhesive composition can be predetermined by selecting the Tg exhibited by the copolymers. In some embodiments, when the copolymers are included in an adhesive composition, the adhesive composition is provided as a film. Before curing, the film of the adhesive composition has a wet thickness. In some embodiments, the film has a 381 micron wet thickness. After curing the film from this thickness, the film exhibits a peak tack of 100 grams of force (gf) or more. Preferably, at a 381 microns wet thickness and after curing, the film exhibits a peak tack of 100 to 1,000 grams of force. The peak tack of the film can be measured with a TA.XT Plus Texture Analyzer using a TA-57R probe and a TA-303 apparatus.

The resulting film may also be cohesive and does not exhibit a residue transfer upon contact, which means that while the film may be tacky it does not leave a deposit upon contact therewith and separation therefrom.

The copolymers also exhibit a desirable particle size. In some embodiments, the z-average particle size of the dispersion of copolymers is 1000 nm or less, preferably not more than 350 nm, more preferably not more than 250 nm, very preferably not more than 200 nm, and at least 20 nm, preferably at least 30 nm, and more preferably at least 50 nm. Preferably, the z-average particle size of the dispersion of copolymers is 50 to 300 nm. As described below, z-average particle size can be measured by the method of Dynamic Light Scattering (DLS) with a Malvern Zetasizer Nano ZS Particle Size Analyzer. The polydispersity (PDI) of the particle size indicates the width of the size distribution.

In some embodiments, the dimensions of the silicone or silane domains within the copolymers after copolymerization has taken place are preferably in the range from 5 nm to 150 nm, more particularly from 10 nm to 140 nm, and especially preferably from 15 nm to 125 nm. The dimensions may be determined, for example, by scanning electron microscopy or transmission electron microscopy on the copolymer dispersions or on the films obtained.

Because of the aforementioned properties, the copolymers are particularly suited for certain applications. For example, in an embodiment, an adhesive composition comprising the copolymers is provided. The adhesive composition may be utilized to provide an adhesive of the PSA variety. In these embodiments, the PSA comprises the copolymers.

Surprisingly, in some embodiments, the aqueous dispersion of copolymers has a low viscosity (<100 mPa·s) even when the amount of water is rather low (<50 wt %, which is based on the total weight of the aqueous dispersion of copolymers). The low viscosity of the aqueous dispersion enables the dispersion to be suitable for application to a surface by spraying. In other embodiments, where the viscosity of the aqueous dispersion is higher, a film applicator can be used to draw a film comprising the dispersion on a surface.

After applying the aqueous dispersion of copolymers to a substrate or before application to a substrate, the copolymer dispersion can be cured. In the present application, curing refers to a process whereby the water is removed from the copolymer dispersion and may also be referred to herein as “drying.” Preferably, water is removed by evaporation thereof, which can be accomplished by evaporating the water therefrom, for example, by heating the aqueous dispersion. The copolymers are said to be cured when they can form a dry film or when the copolymers do not exhibit a weight change of more than 2% upon heating in an oven at 120° C. for 1 hour.

The aqueous dispersion of copolymers may be applied to a substrate using conventional equipment and techniques. Suitable substrates include those commercially available, such as a high surface energy substrate or a low surface energy substrate, such as a metal substrate or polymeric substrate, respectively. The substrates may comprise stainless steel, paper, cardboard, glass, polyolefins, PET, PVC, PMMA, PC, polyurethanes, composites, wood, textile, various other types of plastics and additional materials. Coating a substrate can be accomplished by spraying, knife coating, roller coating, casting, drum coating, dipping and the like and combinations thereof. Coating techniques may include, but are not limited to, Gravure coating, reverse roll coating, Meyer rod coating, Dahlgren coating, knife-over roll coating, slot die coating, immersion coating, curtain coating, etc. Indirect application to a substrate using a transfer process may also be used, in which copolymers are first applied to a release liner instead of directly to a substrate (also called a facestock). After drying, the substate is laminated to the adhesive-coated liner. When the liner and the facestock are separated, the adhesive is transferred from the release liner to the facestock.

A coated article can be formed by applying the adhesive composition over a substrate. The coated article comprises the adhesive composition and a substrate, which is preferably a polymeric substrate. The adhesive composition forms a film on the substate. The film adheres well to the substrate. In fact, the film exhibits a high peel strength. For example, in certain embodiments, a film having a 381 micron wet thickness, after curing at 60° C. for 15 minutes, exhibits a 180 degree peel strength of 1.5 N/inch or more. In one such embodiment, a film having a 381 micron wet thickness, after curing at 60° C. for 15 minutes, exhibits a 180 degree peel strength of 1.5 N/inch to 60 N/inch. Peel strength can be measured by an adhesion/release tester by attaching a stainless steel plate to an outer surface of the film, resting for 30 minutes and then removing the stainless plate at a rate of 300 mm/min (12 in/min). Adhesion/release testers suitable for use in measuring the peel strength include a Shimadzu AGS-X-10kNX tensile tester or a Cheminstruments AR-1000 adhesion/release tester.

When the copolymers are utilized in a PSA adhesive composition, it has been discovered that the PSA retains many of its desirable properties under a variety of conditions. For example, the PSA may retain its adhesive properties in a moist environment, which means that the PSA can be utilized on or in close proximity to sweaty or wet skin. In this embodiment, the PSA may be insoluble in water after curing.

In other embodiments, PSAs comprising the copolymers exhibit improved properties. For example, the PSA may exhibit and improved moisture vapor transmission rate (MVTR). The MVTR can be controlled by varying the organic acrylic monomers. For example, according to WO2001042384A2, the use of hydroxyethylacrylate (HEA) has an impact on the MVTR. Also, the MVTR can be increased by increasing the acrylic acid content in the copolymer (according to the Journal of Applied Polymer Science, Volume 59, Issue 8, Pages 1243-1247). In an embodiment, an adhesive composition of the PSA variety has an MVTR value of >300 g/m²/day when measured according to the above method by using a textile backing. In these embodiments, MVTR can be measured according to ASTM D1653.

Adhesive compositions that include the copolymers can exhibit other advantageous properties. For example, the adhesive composition exhibits excellent stability. In certain embodiments, when the adhesive composition is of the PSA variety, the composition is surprisingly very storage stable. As used herein, storage stability refers to the degree of layer separation observed in the adhesive composition at room temperature over a period of time. In certain embodiments, the adhesive composition does not exhibit any layer separation at 25° C. as measured by the absence of any observable phase separation for 180 days. In some embodiments, the adhesive composition does not exhibit any layer separation at 25° C. as measured by the absence of any observable phase separation for 720 days or more. Stability can also be measured by the absence of variation in z-average particle size. In particular, in an embodiment, the adhesive composition is stable against layer separation at 25° C. as measured by the absence of variation in z-average particle size by more than 20%. In some embodiments, the adhesive composition does not show variation in z-average particle size by more than 20% over at least six months period. The z-average particle sizes for these embodiments can be measured by the method of Dynamic Light Scattering (DLS) with a Malvern Zetasizer Nano ZS Particle Size Analyzer.

When the copolymers are utilized in an adhesive composition that is a PSA, the PSA may exhibit very low residual volatile organic carbon (VOC) or no VOC at all. For example, in an embodiment, the adhesive composition may exhibit a VOC of 2.5% or less. The VOC content of an adhesive composition can be measured according to EPA test method 24.

In other embodiments, the adhesive composition is biocompatible which means that it does not have any observable adverse effect if used on the skin or when used in proximity of human body. In these embodiments, the residual monomeric reaction components such as, for example, the residual organic acrylic monomers should be very low, preferably below 0.5 wt %, based on the total weight of the cured adhesive composition.

As noted above, the adhesive composition can be utilized in medical applications such as, for example, wound care and other healthcare applications such as in medical tapes, adhesive patches, wound care dressings, ostomy care, drug delivery, cosmetic patches, wearables and other applications. Such adhesive tapes can be of the PSA variety and include the copolymers formed by the process, which are useful in medical applications requiring a low trauma characteristics, which means that the adhesive adheres to skin but does not exhibit excessive adhesion build over time which would result in a difficult, and thus painful, removal.

Because of the diversity of potential medical applications, it can be important that compositions including the copolymers are capable of exhibiting a broad spectrum of physical properties. For example, such a compositions including the copolymers may exhibit a hydrophobicity/hydrophilicity that can be controlled by careful selection of the appropriate monomer or combination thereof. For example, in certain embodiments, an adhesive composition, such as of the PSA variety, may be provided that has relatively hydrophilic properties by incorporating hydrophilic monomers during the polymerization, such monomers include 2-hydroxymethacrylate and acrylamide.

In certain embodiments, the adhesive composition may also comprise a drug or an active compound, an adhesive resin, a penetration enhancer, a water absorptive material, a lenitive and/or a tackifying agent. Examples of suitable adhesive resins include polyacrylates, natural or synthetic rubbers, and the like. Suitable penetration enhancers include polar materials capable of forming strong hydrogen bonds, such as urea, which polarize the user's skin molecules and increase the skin's permeability through ionic force. Another suitable polar agent, which is suitable for use in the adhesive composition is a solution of DMSO (dimethylsulfoxide). Other examples of suitable agents include nonionic surfactants or solvents having an hydrophile lipophile balance (HLB) value from about 6-30. As used herein, the term “HLB” refers to a numeric expression of the ability to emulsify non-soluble ingredients in oil and water. These agents may be selected from chemical groups of glycerol esters, polyglycerol esters, alkyl fatty acid esters, ethoxylated sorbitan esters, alcohol ethoxylates, lanolin ethoxylates, ethoxylated fatty methyl esters and alkanolamides. Preferably, in these embodiments, the agent has an HLB value from about 8-28. Examples of suitable agents having an HLB value of 8-10 include PEG 200 monolaurate, sorbitan monolaurate, POE myristylether, POE lauryl alcohol, POE lauryl ether, POE sorbitan monooleate, octyphenoxypoly (ethyleneoxy)ethanol, linear alcohol ethoxylate, mono and diglycerides with polysorbate 80, nonyl phenol ethoxylate, alkylaryl polyether ethanol, N,N-dimethyl amide. Examples of agents having an HLB value from 11-14 include PEG 400 monooleate, polyoxyaryl ether, POE oleyl alcohol, PEG 600 monooleate, POE sorbitan monooleate, PEG 400 monolaurate, POG laurylalcohol and nonylphenoxypoly(ethyleneoxy)ethanol. Examples of agents having an HLB value from 15-28 include nonyl phenol ethoxylate, castor oil ethoxylate, ethoxylated cocomonoglyceride, oleylalcohol condensed with ethylene oxide, modified oxyethylated straight chain alcohol, ethoxylated lanolin alcohol, nonylphenyl ethoxylate, polyethylene 100 stearyl ether, PEG 6000 monooleate, ethoxylated polyoxypropylene glycols and ethoxylated polyoxypropylene glycols. Preferably, the agent is provided in an amount of about 1-50 weight percent, based on the total weight of the adhesive composition before curing. Examples of water absorptive materials could be selected from highly water-absorptive polymers, polyols and water-absorptive inorganic materials. Examples of the highly water-absorptive polymers may include mucopolysaccharides such as hyaluronic acid, chondroitin sulfate, dermatan sulfate and the like, polymers having a large number of hydrophilic groups in the molecule such as chitin, chitin derivatives, starch and carboxy-methylcellulose, and semi-synthetic and synthetic highly water-absorptive polymers such as polyacrylic, polyoxyethylene, polyvinyl alcohol and polyacrylonitrile. Examples of the water-absorptive inorganic materials, which may be incorporated into an adhesive to regulate its water absorptive capacity, may include powdered silica, zeolite, powdered ceramics and the like. Examples of the polyols may include propylene glycol, glycerin, sorbitol and the like. Suitable tackifiers can be selected from the group consisting of a hydrocarbon resin, hydrogenated hydrocarbon resin, a fully hydrogenated hydrocarbon resin, a hydrogenated rosin ester, a fully hydrogenated rosin ester, and combinations thereof. Examples of suitable lenitive agents are alpha-bisabolol, camomile oil, allantoin, and d-panthenol.

Although the copolymers are prepared in water, an adhesive composition comprising the copolymers is preferably dry, which means that it contains very little or no residual water when in use. Thus, in certain embodiments, it may be desired that the copolymers are hydrophobic and generally impart hydrophobic properties to the adhesive composition which results in low water uptake and better adhesive properties.

The embodiments of the adhesive composition described herein should provide good adhesion properties. However, the adhesive compositions can also be blended with other adhesives to obtain optimum properties for a specific application. Also, tackifying agents can be added to the adhesive composition to adjust the properties exhibited. Other additives suitable for use in the adhesive composition may include wetting agents, defoaming agents, and/or coalescing agents.

A composition that includes the copolymers may also be utilized to provide a matrix for containing one or more active ingredients. Advantageously, such actives can be incorporated into such compositions and can be released at a controlled rate from the same. Such compositions can also have the aforementioned adhesive properties. Thus, in certain embodiments, the adhesive composition described above can be used for controlled release of one or more active substances. Active substances suitable for use in the adhesive composition may be referred to herein simply as an “active” or “actives.”

Preferably, the active utilized is compatible with an aqueous dispersion. Water-soluble or partially water-soluble actives are more suitable. Non-limiting examples of such actives include melamine, niacinamide, Benadryl, vitamin C, etc. Water-insoluble actives can also be used in which case the actives can be added in an emulsified form to be compatible with the aqueous dispersion of copolymers. For example, in some embodiments, water-insoluble actives can be encapsulated, for example encapsulated inside a cyclodextrin cavity or inside other encapsulating agents, to make them compatible with the aqueous dispersion.

The active is preferably incorporated into the adhesive composition, for example, a PSA composition, before curing takes place. The active may be a pharmacologically active such as, for example, a cannabinoid. However, the active may also be suitable for use in cosmetic, wound care, wellness, or performance enhancing applications. The actives suitable for use can be delivered topically or transdermally.

In some embodiments, the active may be a cannabinoid. In addition to cannabinoids, pharmacologically actives suitable for use include oxymorphone, caffeine, zidovudine, pilocarpine, ranitidine, lazabemide, thiopental, scopolamine, butabarbital, digoxin, tiapride, pemoline, diclofenac, antipyrine, albuterol, oxycodone, terbutaline, ephedrine, pseudoephedrine, morphine, captopril, mescaline, naloxone, phenelzine, secobarbital, flumazenil, fluvastatin; sumatriptan, oxcarbazepine, modafinil, moclobemide, nadolol, aldosterone, pentaerythritol, prazosin, ramipril, guanfacine, physostigmine, phenobarbital, minoxidil, aprobarbital, naltrexone, leflunomide, terazosin, pindolol, fludrocortisone, mephobarbital, profentofylline, methysergide, transylcypromine, prednisone, hydromorphone, dantrolene, hydrocortisone, talipexole, lidocaine, metoprolol, betamethasone, timolol, lesopitron, benzocaine, clobazam, colchicine, butalbital, prilocalne, atropine, mepivacaine, procaine, pentobarbital, amobarbital, clorazepate, yohimbine, temazepam, hydrocodone, phenyloin, trimethobenzamide, warfarin, carbamazepam, nedociomil, buspirone, ketorolac, oxazepam, piribedil, pramipexole, secobarbital, hydrocortisone, lorazepam, chlordiazepoxide, quetiapine, enalapril, betamethasone acetate, tamsulosin, nifedipine, ergotamine, clonazepam, atorvastatin, tolmetin, bumetanide, piroxicam, perindopril, propranolol, mexiletene, chlorzoxazone, indapamide, diazepam, ciciopirox, ramipril, amphetamine, benztropine, methylphenidate, apomorphine, diltiazem, alprenolol, clozapine, ropivacaine, valproic acid, norethindrone, ketoprofen, tramadol, tetracaine, etorphine, flurazepam, meperidine, ropinirole, carvedilol, bupranolol, pravastatin, naproxen, diphenhydramine, ketamine, albendazole, idebenone, tacrine, finasteride, nabumetone, gestodene, testosterone, venlafaxine, estazolam, rimantadine, phentolamine, propafenone, levorphanol, bupivicaine, perindopril, droperidol, celecoxib, norgestrel, isradipine, risperidone, benazepril, loratidine, betamethasone, progesterone, butorphanol, papaverine, quinapril, alprostadil, prostaglandin, citalopram, ibuprofen, flurbiprofen, chlorpheniramine, zolpidem, alprazolam, fentanyl, nisoldipine, benztropine, betamethasone, etodolac, tibolone, estradiol, adamantane, chlormadinine, oxybutynin, triazolam, doxepin, prazepam, capsaicin, granisetron, frovatriptan and norethindrone acetate.

Other actives suitable for use in practicing the method include antioxidants, free radical scavengers, moisturizers, depigmentation agents, reflectants, humectants, antimicrobial (e.g., antibacterial) agents, allergy inhibitors, anti-acne agents, anti-aging agents, anti-wrinkling agents, antiseptics, analgesics, antitussives, antipruritics, local anesthetics, anti-hair loss agents, hair growth promoting agents, hair growth inhibitor agents, antihistamines, keratolytic agents, anti-inflammatory agents, fresheners, healing agents, anti-infectives, inflammation inhibitors, anticholinergics, vasoconstrictors, vasodilators, wound healing promoters, peptides, polypeptides and proteins, deodorants and antiperspirants, skin emollients and skin moisturizers, hair conditioners, hair softeners, hair moisturizers, tanning agents, skin lightening agents, antifungals such as antifungals for foot preparations, depilating agents, external analgesics, counterirritants, hemorrhoidals, insecticides, poison ivy products, poison oak products, burn products, anti-diaper rash agents, prickly heat agents, make-up preparations, vitamins, amino acids and their derivatives, herbal extracts, retinoids, flavoids, sensory markers (e.g. cooling agents, heating agents, etc.), skin conditioners, hair lighteners, chelating agents, cell turnover enhancers, coloring agents, sunscreens, anesthetics, immunomodulators and nourishing agents, moisture absorbers, sebum absorbers and the like, and mixtures thereof. Local anaesthetics, local antibiotics, antiseptics, antimycotics, antihistaminics, and antipruritic drugs, keratolytics and caustic drugs, virustatics, antiscabietic agents, steroids, as well as different substances for the treatment of acne, psoriasis, photodermatoses, or precancerous stages can be used in the method for the dermal treatment.

In certain embodiments, actives which are directed intradermally can be utilized. Actives applicable by way of the intradermal route include, for example, steroid and nonsteroid antirheumatics, local anaesthetics, substances stimulating the blood flow, vasoprotectors and vasoconstrictors to treat vascular diseases, as well as active substances to influence processes in the subcutaneous fatty tissue.

Additional actives suitable for use include, for example, analgesics, anti-arrhrythmic drugs, narcotics and their antagonists, neuroleptics, hormones or hormone substitutes, antidepressants, tranquilizers, hypnotics, psychostimulants, antiparkinson drugs, ganglionic blockers, sympathomimetics, alpha-sympatholytics, beta-sympatholytics, antisympathotonics, antiasthmatics, antiemetics, appetite depressants, diuretics, or active substances for weight reduction, and the like.

In some embodiments, suitable actives are capable of providing an effect at very low concentrations. Examples of these actives include steroids, such as estradiol, estriol, progesterone, norethisterone, norethindrone, levonorgestrel and their derivatives, as well as estradiol diacetate, norgestamate, gestagens, desogestrel, dern egestrone, pro megestrone, testosterone, hydrocortisones and their derivatives, nitro compounds, such as amyl nitrate, nitroglycerin, isosorbide dinitrate, amine compounds, such as nicotine, chlorpheniramine, terfenadine, and triprolidine, oxicam derivatives such as piroxicam, mucopolysaccharases such as thiomucase, opioid substances such as buprenorphine, morphine, fentanyl and their salts, derivatives or analogues, naloxone, codeine, dihydroergotamine, lysergic acid derivatives, pizotiline, salbutamol, terbutaline, prostaglandins, such as PGA, PGB, PGE and the PGF series, for example, misoprostol and enprostil, omeprazol, imipramine, benzamides, such as metoclopramines and scopolamine, peptides and growth factors such as EGF, TGF, PDGF, and the like, somatostatin, clonidine, dihydropyridines, such as nifedipine, nitrendipine, verapamil, diltiazem, ephedrine, propanolol, metoprolol, spironolactone, thiazides such as hydrochlorothiazide and flunarizine. Styptic or wound-cleansing actives such as enzymes, antiseptics, disinfectants, and antibiotics, pain relieving agents and anesthetic actives, as well as active substances promoting wound healing to stimulate granulation, to induce vascularization, or to promote epithelization can be used. In some embodiments, the active could be a steroid hormone, preferably estradiol either alone or combined with other actives.

Actives derived from vegetable preparations, such as extracts or tinctures for the treatment of topical skin diseases are also suitable. Suitable extracts or tinctures include oak bark extract, walnut extract, tincture of arnica, hamamelis extract, ribwort extract, pansy extract, thyme or sage extract, St. John's wort tincture, cone flowers tincture, chamomile flowers extract, or calendula flowers tincture, birch leaves extract, nettle extract, coldsfoot extract, comfrey tincture, horsetail extract, or aloe vera extract. Additional actives for the intradermal treatment of diseases suitable for use include, for example, extracts of horse chestnut and butcher's broom in case of vein diseases, or extracts and tinctures of arnica, calendula, and capsicum in case of contusions, distortions, or hemorrhages. Suitable actives from vegetable preparations may also be used in transdermal therapy, for example, ginseng extract, valerian tincture, extracts of melissa and hop, extracts of kola and tea, or hawthorn extract.

Suitable effervescent actives, including sodium bicarbonate and sodium carbonate, can be utilized. Suitable amino acid actives, including amino acids derived from the hydrolysis of various proteins as well as the salts, esters, and acyl derivatives thereof, can be utilized. Examples of such amino acid agents include amphoteric amino acids such as alkylamido alkylamines, stearyl acetyl glutamate, capryloyl silk amino acid, caprylol collagen amino acids, capryloyl kertain amino acids, capryloyl pea amino acids, cocodimonium hydroxypropyl silk amino acids, corn gluten amino acids, cysteine, glutamic acid, glycine, hair keratin amino acids, hair amino acids such as aspartic acid, threonine, serine, glutamic acid, proline, glycine, alanine, half-cystine, valine, methionine, isoleucine, leucine, tyrosine, phenylalanine, cysteic acid, lysine, histidine, arginine, cysteine, tryptophan, citrulline, lysine, silk amino acids, wheat amino acids, and mixtures thereof.

Suitable peptides, polypeptides, and proteins can be utilized as actives including those polymers that have a long chain, such as at least about 10 carbon atoms, and a high molecular weight, such as at least about 1000, and are formed by self-condensation of amino acids. Examples of such proteins include collagen, deoxyribonuclease, iodized corn protein, keratin, milk protein, protease, serum protein, silk, sweet almond protein, wheat germ protein, wheat protein, wheat protein, alpha and beta helix of keratin proteins, hair proteins, such as intermediate filament proteins, high-sulfur proteins, ultrahigh-sulfur proteins, intermediate filament-associated proteins, high-tyrosine proteins, high-glycine tyrosine proteins, tricohyalin, and mixtures thereof.

Vitamins can be utilized as actives in the method. Examples of suitable vitamins that can be used include vitamin B complex, including thiamine, nicotinic acid, biotin, pantothenic acid, choline, riboflavin, vitamin B6, vitamin B12, pyridoxine, inositol, carnitine, vitamins A, C, D, E, K and their derivatives such as vitamin A palmitate and provitamins, such as panthenol (pro vitamin B5) and panthenol triacetate, and mixtures thereof.

Antibacterial agents can be utilized as actives. Examples of suitable antibacterial agents that can be used include bacitracin, erythromycin, neomycin, tetracycline, chlortetracycline, benzethonium chloride, phenol, and mixtures thereof.

Skin emollients and skin moisturizers can be utilized as actives. Examples of suitable skin emollients and skin moisturizers that can be used include mineral oil, lanolin, vegetable oils, isostearyl isostearate, glyceryl laurate, methyl gluceth 10, methyl gluceth 20 chitosan, and mixtures thereof.

Hair conditioners can be utilized as actives. Examples of suitable hair conditioner actives include quaternized compounds such as behenamidopropyl PG-dimonium chloride, tricetylammonium chloride, dehydrogenated tallowamidoethyl hydroxyethylmonium methosulfate, and mixtures thereof as well as lipophilic compounds like cetyl alcohol, stearyl alcohol, hydrogenated polydecene, and mixtures thereof.

Sunscreen agents can be utilized as actives. Examples of sunscreen agents that can be used as actives include butyl methoxydibenzoylmethane, octyl methoxycinnamate, oxybenzone, octocrylene, octyl salicylate, phenylbenzimidazole sulfonic acid, ethyl hydroxypropyl aminobenzoate, menthyl anthranilate, aminobenzoic acid, cinoxate, diethanolamine methoxycinnamate, glyceryl aminobenzoate, titanium dioxide, zinc oxide, oxybenzone, padimate o, red petrolatum, and mixtures thereof.

Tanning agents and skin lightening agents can be utilized as actives. An example of a suitable tanning agent that can be utilized as an active is dihydroxyacetone. Examples of suitable skin lightening agents that can be used include hydroquinone, catechol and its derivatives, ascorbic acid and its derivatives, and mixtures thereof.

Insecticides can be utilized as actives. Examples of suitable insecticides include permethrin, pyrethrin, piperonyl butoxide, imidacloprid, N, N-diethyl toluamide, which refers to the material containing predominantly the meta isomer.

Anti-fungals for foot preparations that can be used as actives include those with antifungal properties such as tolnaftate.

Depilating agents can be utilized as actives. Examples of suitable depilating agents include calcium thioglycolate, magnesium thioglycolate, potassium thioglycolate, strontium thioglycolate, and mixtures thereof.

Analgesics and local anesthetics can be utilized as actives. Examples of suitable external analgesics and local anesthetics that can be used include benzocaine, dibucaine, benzyl alcohol, camphor, capsaicin, capsicum, capsicum oleoresin, juniper tar, menthol, methyl nicotinate, methyl salicylate, phenol, resorcinol, turpentine oil, and mixtures thereof.

Antiperspirants and deodorants that can be used as actives. Examples of suitable antiperspirants and deodorants that can be used as actives include aluminium chlorohydrates, aluminium zirconium chlorohydrates, and mixtures thereof.

In some embodiments, the active may be a counterirritant. Examples of suitable counterirritants that can be used include camphor, menthol, methyl salicylate, peppermint and clove oils, ichthammol, and mixtures thereof.

In some embodiments, the active may be an inflammation inhibitor such as, for example, hydrocortisone. In other embodiments, the active may be a hemorrhoidal product. Examples of suitable hemorrhoidal products include anesthetics such as benzocaine, pramoxine hydrochloride, and mixtures thereof; antiseptics such as benzethonium chloride, astringents such as zinc oxide, bismuth subgallate, balsam Peru, and mixtures thereof, skin protectants such as cod liver oil, vegetable oil, and mixtures thereof.

Benefit agents are also suitable for use as actives. Suitable benefit agents include therapeutic agents that are effective in the treatment of dandruff, seborrheic dermatitis, and psoriasis as well as the symptoms associated therewith. Examples of such suitable therapeutic agents include zinc pyrithione, shale oil and derivatives thereof such as sulfonated shale oil, selenium sulfide, sulfur, salicylic acid, coal tar, povidone-iodine and imidazoles.

In some embodiments, the active may be an antimicrobial, an antiseptic, or a keratolytic agent. Antimicrobials that can be utilized for topical application are penicillins, cephalosporins, other beta-lactam compounds, aminoglycosides, tetracyclines, erythromycin, antifungal agents, and the like and a combination thereof. Antiseptics that can be utilized as actives for topical application onto acneiform skin are triclosan (Irgasan DP 300), phenoxy isopropanol, resorcinol, chlorhexidine, povidone and iodine. Keratolytic agents that can be utilized for topical application onto acneiform skin are salicylic acid, benzoyl peroxide, sulphur, retinoic acid and any of a number of fruit acids and alpha hydroxy acids.

In other embodiments, the active may be an anti-irritant. Suitable anti-irritants for the topical application onto acneiform skin are alpha-bisabolol, famesol, chamomile extract and glycyrrhetinic acid.

In some embodiments, the active may be an anti-inflammatory analgesic agent. Examples of anti-inflammatory analgesic agents suitable for use in the method include acetaminophen, methyl salicylate, monoglycol salicylate, aspirin, mefenamic acid, flufenamic acid, indomethacin, diclofenac, alclofenac, diclofenac sodium, ibuprofen, ketoprofen, naproxen, pranoprofen, fenoprofen, sulindac, fenclofenac, clidanac, flurbiprofen, fentiazac, bufexarnac, piroxicam, phenylbutazone, oxyphenbutazone, clofezone, pentazocine, mepirizole, tiaramide hydrochloride, and the like.

In certain embodiments, the active may be a steroidal anti-inflammatory agent. Examples of steroidal anti-inflammatory agents that can be used in the method include hydrocortisone, predonisolone, dexamethasone, triamcinolone acetonide, fluocinolone acetonide, hydrocortisone acetate, predonisolone acetate, methylpredonisolone, dexamethasone acetate, betamethasone, betamethasone valerate, flumetasone, fluorometholone, beclomethasone diproprionate, and the like.

Antihistamines are also suitable for use as actives. Examples of antihistamines include diphenhydramine hydrochloride, diphenhydramine salicylate, diphenhydramine, chlorpheniramine hydrochloride, chlorpheniramine maleate isothipendyl hydrochloride, tripelennamine hydrochloride, promethazine hydrochloride, methdilazine hydrochloride, and the like.

In certain embodiments, the active may be a local anesthetic including, for example, dibucaine hydrochloride, dibucaine, lidocaine hydrochloride, lidocaine, benzocaine, p-buthylaminobenzoic acid 2-(die-ethylamino)ethyl ester hydrochloride, procaine hydrochloride, tetracaine, tetracaine hydrochloride, chloroprocaine hydrochloride, oxyprocaine hydrochloride, mepivacaine, cocaine hydrochloride, piperocaine hydrochloride, dyclonine, dyclonine hydrochloride, and the like.

In other embodiments, the active may be a bactericide or a disinfectant. Bactericides and disinfectants that can be utilized include thimerosal, phenol, thymol, benzalkonium chloride, benzethonium chloride, chlorhexidine, povidone iode, cetylpyridinium chloride, eugenol, trimethylammonium bromide, and the like.

In other embodiments, the active may be a vasoconstrictor, hemostatic, chemotherapeutic drug, or an antibiotic. Examples of vasoconstrictors suitable for use include naphazoline nitrate, tetrahydrozoline hydrochloride, oxymetazoline hydrochloride, phenylephrine hydrochloride, tramazoline hydrochloride, and the like. Examples of hemostatics suitable for use include thrombin, phytonadione, protamine sulfate, aminocaproic acid, tranexamic acid, carbazochrome, carbaxochrome sodium sulfanate, rutin, hesperidin, and the like. Examples of chemotherapeutic drugs that can be used include sulfamine, sulfathiazole, sulfadiazine, homosulfamine, sulfisoxazole, sulfisomidine, sulfamethizole, nitrofurazone, and the like. Examples of antibiotics include penicillin, meticillin, oxacillin, cefalotin, cefalordin, erythromcycin, lincomycin, tetracycline, chlortetracycline, oxytetracycline, metacycline, chloramphenicol, kanamycin, streptomycin, gentamicin, bacitracin, cycloserine, and the like.

Suitable actives include antiviral drugs such as protease inhibitors, thymadine kinase inhibitors, sugar or glycoprotein synthesis inhibitors, structural protein synthesis inhibitors, attachment and adsorption inhibitors, and nucleoside analogues such as acyclovir, penciclovir, valacyclovir, and ganciclovir.

Further suitable actives include alpha-hydroxy acids (AHAs) which can be used as exfoliants, moisturizers, and emollients, lactic acid salts such as sodium lactate, and salicylic acid, which can be used as peeling agents. The moisturizing activity of AHAs and their ability to exfoliate the skin and interfere with intercellular cohesion in the outer epidermis is well known. It has been suggested that AHAs interfere with cohesion in the stratum granulosum, unlike salicylic acid and other exfoliants.

In certain embodiments, actives which have an effect on the skin can be utilized. Such actives may be of the cosmetic variety such as, for example, melatonin or niacinamide. Another suitable skin effecting active is vitamin C (ascorbic acid) can be used in practicing the method. In some embodiments, vitamin C may be provided in a mixture including vitamin E and other ingredients, such as moisturizers, collagen synthesis promoting agents and exfoliating agents. In other embodiments, vitamin C may be provided with vitamin E, and optionally, alpha-hydroxy acids, such as lactic and glycolic acids and other keratinolytics for the treatment or prevention of wrinkles and skin dryness.

Further examples of actives of the cosmetic variety include D-alphatocopherol, DL-alphatocopherol, D-alpha-tocopheryl acetate, DL-alpha-tocopheryl acetate, ascorbyl palmitate, vitamin F and vitamin F glycerides, vitamin D, retinol, retinol esters, retinyl palmitate, retinyl propionate, beta-carotene, D-panthenol, famesol, farnesyl acetate, jojoba oils and blackcurrant oils rich in essential fatty acids, 5-n-octanoylsalicylic acid and esters thereof, salicylic acid and esters thereof, alkyl esters of alpha-hydroxy acids such as citric acid, lactic acid, glycolic acid, asiatic acid, madecassic acid, asiaticoside, total extract of Centella asiatica, beta-glycyrrhetinic acid, alpha-bisabolol, ceramides such as 2-oleoylamino-1,3-octadecane; phytanetriol, phospholipids of marine origin which are rich in polyunsaturated essential fatty acids, ethoxyquine, extract of rosemary, extract of balm, quercetin, extract of dried microalgae, anti-inflammatory agents, such as steroidal anti-inflammatory agents, and biostimulants, for example hormones or compounds for the synthesis of lipids and/or proteins.

Other examples of actives suitable for use include vitamin D3, iron in any form, zinc in any form (such as zinc citrate), folic acid, melatonin, niacinamide, green tea or extract, ginseng, arnica, turmeric, curcumin, cannabinoids, tea tree oil, clortrimazole, hyaluronic acid, alpha hydroxy acids, resveratrol, argan oil, and CoQ10.

In some embodiments, the active can be delivered in its free base or acid form, or in the form of salts, esters, or any other acceptable derivative, or as a component of a molecular complex. It should be appreciated that even when not specifically mentioned, the actives described above could also be delivered as a mixture of actives.

### EXAMPLES

The following examples are presented solely for the purpose of further illustrating and disclosing the embodiments of the process for forming an aqueous dispersion of copolymers and adhesive compositions including such copolymers. Examples within the scope of the invention include Examples 1-9, which are described below. Two Comparative Examples, which are not part of the invention, are also described below.

Further, in this section, substances are characterized below by reporting of data obtained by means of instrumental analysis. The underlying measurements were carried out either in accordance with publicly accessible standards or determined using specially developed techniques. In order to ensure the clarity of the teaching imparted, the methods used are specified hereinbelow.

In all examples, all figures for parts and percentages are given by weight, unless otherwise indicated.

### Viscosity:

The viscosities, unless otherwise indicated, were determined by measurement using rotational viscometry in accordance with DIN EN ISO 3219 by using a Brookfield viscometer [spindle LV 1, 10 rpm]. Unless indicated otherwise, all viscosity figures are for 25° C. and atmospheric pressure of 1013 mbar.

### Molecular Compositions:

The molecular compositions are determined by nuclear magnetic resonance spectroscopy (regarding terminology see ASTM E 386: 35 High-Resolution Nuclear Magnetic Resonance Spectroscopy (NMR): terms and symbols), with measurement of the ¹H nucleus and the ²⁹Si nucleus.

### Description of 1H NMR Measurement:

Solvent: CDCl₃, 99.8% d
Sample concentration: about 50 mg/l ml CDCl3 in 5 mm NMR tubes
Measurement without addition of TMS, referencing of spectra with residual CHCl₃ in CDCl₃ at 7.24 ppm 5
Spectrometer: Bruker Avance 400
Sample head: 5 mm BBO sample head or SMART sample head (from Bruker)
Measurement parameters: 10
Pulprog=zg30
TD=64 k
NS=64 or 128 (depending on the sensitivity of the sample head)
SW=20.6 ppm
AQ=3.17 s 15
D1=5 s
SFO1=500.13 MHz
O1=6.175 ppm

### Processing Parameters:

SI=32 k 20
WDW=EM
LB=0.3 Hz
   According to the type of spectrometer used, individual adjustments to the measurement parameters may be required.

### Description of ²⁹Si NMR MEASUREMENT

Solvent: C₆D₆ 99.8% d/CCl₄ 1:1 v/v with 1 wt % Cr(acac)₃ as relaxation reagent
Sample concentration: about 2 g/1.5 ml solvent in 10 mm NMR 30 tubes
Spectrometer: Bruker Avance 400
Sample head: 10 mm ¹H/¹³C/¹⁵N/²⁹Si glass-free QNP sample head (from Bruker)

### Measurement Parameters:

Pulprog=zgig60
TD=64 k
NS=1024 (depending on the sensitivity of the sample head)
SW=200 ppm
AQ=2.75 s
D1=4 s
SFO1=300.13 MHz
O1=−50 ppm 5

### Processing Parameters:

SI=64 k
WDW=EM
LB=0.3 Hz
   According to the type of spectrometer used, individual adjustments to the measurement parameters may be required.

### Molecular Weight Distributions:

Molecular weight distributions are determined as the weight average M_{w} and the number average Mₙ, employing the method of gel permeation chromatography (GPC or size exclusion chromatography (SEC)) with polystyrene standard and a refractive index detector (RI detector). Unless specified otherwise, THF is used as the eluent and DIN 55672-1 is employed. The polydispersity is the quotient M_{w}/Mₙ.

### Glass Transition Temperatures:

The glass transition temperature is determined by Differential Scanning calorimetry (DSC) according to DIN 53765, pierced crucible, heating rate 10 K/min.

### Determination of the Particle Size:

The particle sizes (z-average particle size) were measured by the method of Dynamic Light Scattering (DLS) with a Malvern Zetasizer Nano ZS Particle Size Analyzer. The polydispersity (PDI) of the particle size indicates the width of the size distribution.

### Measurement of Tack:

Tack was measured on adhesive films of 381 microns wet thickness drawn on a MYLAR™ film. The MYLAR™ films were corona treated if necessary. To measure the probe tack, a TA.XT plus Texture Analyzer with a TA-57R probe and a TA-303 apparatus for consistent placement of the tested substrate was used. The peak tack is reported for each sample and expressed in grams of force (gf), which results from the probe head contacting the surface of the sample and then pulling away and off the sample. For each example, five samples were taken and tested. The final peak tack value is the arithmetic mean from the corresponding five peak tack results unless otherwise noted.

### Measurement of 180° Peel Stress:

Adhesive compositions of 381 microns wet film thickness were coated on a MYLAR® film. The MYLAR™ film was corona treated if necessary. After being coated, the film was cured in an oven at 60° C. for 15 min. The sample with the Mylar® backing was cooled and applied to a polished stainless steel testing plate. The sample was allowed to rest on the steel plate for 30 min or 1 hour. The peel strength was measured using a Shimadzu AGS-X-10kNX tensile tester at a rate of 300 mm/min or a Cheminstruments AR-1000 adhesion/release tester at a rate of 12 in/min.

### Measurement of Static Shear Stress:

An adhesive composition of appropriate thickness was coated on a Mylar® film. The film was dried in an oven at 60° C. for 15 min. The sample with the Mylar® backing was cooled, cut and applied on a polished stainless-steel panel. Pressure was applied on the sample portion of the steel panel using a 5 lb-weighted rubber roller in four strokes (two sets of back-and-forth strokes). The steel plate was placed in a vertical sample holder and a weight of 1 kg was attached. Sample contact area measured 1 in X 0.5 in. The time taken for the weight to drop, i.e., the time taken for the adhesive to fail, was measured.

### Measurement of Volatile Organic Carbon (VOC):

VOC was measured according to EPA test method 24.

### Measurement of Water Contact Angle:

Water contact angle was measured using a KRÜSS Mobile Surface Analyzer on a dried adhesive film on an aluminum Q-panel

### Measurement of Moisture Vapor Transmission Rate:

An adhesive composition of 203.2 microns wet film thickness was coated on a nonwoven fabric. The film was dried in an oven at 60° C. for 15 min. The sample with the nonwoven fabric backing was cooled, cut into a circular shape with a 5.6 cm diameter, and mounted on a GARDCO® Perm Cup prefilled with 10.00±0.05 g of deionized water. Moisture vapor transmission rate was measured using the “Wet (Payne) Cup Method” for ASTM D1653.

### Franz Cell:

The examples provided below that refer to the release of melatonin or niacinamide were conducted using a Franz diffusion cell (Franz cell) through a disc of cellulose acetate membrane. The Franz cells described in the examples were DHC-6AT Dry Heat Transdermal Diffusion Cell Transdermal Systems sold by the Logan Instruments Corp. The cellulose acetate membrane had a molecular weight cut-off of 12-14. Before use in the studies, each cellulose acetate membrane was soaked in 20% EtOH-in-water solution for 1 hour to remove any non-bound chemicals.

To study the release of the actives referred to in Examples 7 and 8, gel samples were formed and die-cut into portions having a circular shape and a 1.5 cm diameter. These portions were mounted on a cellulose acetate membrane and the release of melatonin or niacinamide was measured. In these examples, a 20% EtOH-in-water solution was used as the receptor cell fluid. The receptor cell temperature of the Franz cell was set to 37° C. while having the solution stirred at a constant rate of approximately 600 rpm. Samples of the solution were taken at various time points over the studies. Each time after collecting a solution sample, an aliquot of 1.00 mL was removed and replaced with a fresh amount of the same fluid. In Examples 7 and 8, the melatonin and niacinamide concentrations in the collected samples were determined by high pressure liquid chromatography.

Preparation of an Ethylenically Functionalized Silicone Resin B1 by Condensation of Ethoxy-Functional Silicone Resin with Methacryloxypropyltrimethoxysilane

(CH₃O)₃Si(CH₂)₃OC(═O)C(CH₃)═CH₂

A methacryloxypropyl functional silicone resin was prepared by condensing together tetraethyl silicate oligomer having an average degree of oligomerization of 9, hexamethyldisiloxne, 3-methacryloxypropyltrimethoxysilane and a low-viscosity, OH-terminated polydimethylsiloxane having on average 45 siloxane units. The condensation reaction is carried out in presence of water and catalyst hydrochloric acid. The detailed procedure is described in US 2018/0305576. The resin is diluted with 25% butyl acrylate. Following are the properties of the methacryloxypropyl functional silicone resin:

### Molecular Weight:

$$\begin{matrix}{M}_{w} = 4018 g / mol \\ {M}_{n} = 1557 g / mol \\ PD = 2.58\end{matrix}$$

Molecular Composition from ¹H NMR and ²⁹Si NMR:
Me₃SiO_{1/2}: 23.18 mol %
Me₂SiO_{2/2}: 20.66 mol %
((CH2)₃OC(═O)C(CH₃)═CH₂)SiO_{3/2}: 0.72 mol %
SiO_{4/2}: 37.30 mol %
EtO-Si: 3.68 mol %
MeO-Si: 0.12 mol %

### Example 1: Preparation of an Aqueous Dispersion of Copolymers from the Ethylenically Functionalized Silicone Resin B1 and Organic Acrylic Monomers (1:9 Silicone: Organic Acrylic Monomers)

### Step 1: Preparation of Miniemulsion

The miniemulsion is prepared by dissolving the silicone resin B1, a mixture of (meth)acrylic monomers, followed by high pressure homogenization. In this example, a IKA® HPH 2000/5 high pressure homogenizer was utilized to prepare the miniemulsion.

The following components were added to a sealable vessel and mixed on an orbital shaker:

| Component | Weight (grams) |
|---|---|
| Resin B1 solution containing | 104.74 |
| 25% butyl acrylate | |
| 2-Ethylhexyl acrylate | 459.39 |
| Methyl acrylate | 207.15 |
| Acrylic acid | 14.18 |
| Hexadecane | 2.40 |

The resulting mixture was combined with a solution of the following components and mixed on an orbital shaker for approximately 1 hour:

| | Weight |
|---|---|
| Component | (grams) |
| Polymerizable surfactant Hitenol | 25.27 |
| KH-10 | |
| Hydroquinone monomethylether | 3.69 |
| (2% solution in water) | |
| Reverse osmosis water | 433.74 |

The pre-emulsion was passed through the high-pressure homogenizer at a pressure of 400-800 bar to obtain a miniemulsion with a z-average particle size of 233 nm (PDI=0.32).

### Step 2: Polymerization

A 3 liter polymerization vessel, equipped with an anchor stirrer, a reflux condenser, a thermometer, and a nitrogen inlet, was charged with 236.11 grams of deionized water, and 68 grams of the miniemulsion prepared in Step 1 as the initial charge and heated to 50° C. with stirring. In one sealable vessel, 6.26 grams of 70 wt % strength aqueous solution of tert-butyl hydroperoxide (TBHP) diluted with 40.38 grams deionized water (feed 1) was provided. In a second sealable vessel, a solution of 2.19 grams of a formaldehyde-free reducing agent (Bruggolite® FF6 M) in 42.42 grams of reverse osmosis water (feed 2) was provided. In a third vessel, 855.7 grams of the miniemulsion (feed 3) was provided. Feed 1 and 2 were started at a rate of 220 μL/min, followed by the start of feed 3 at a rate of 5.0 mL/min. All three feeds were continuously metered over a period of 165 minutes. Feeds 1 and 2 were continued for an additional 30 minutes after the completion of feed 3, and the reaction was then held at 50° C. for an additional 60 minutes. After cooling to room temperature, the product was adjusted to a pH of 8 by the addition of aqueous ammonia. Biocide (Acticide BW 20, 0.25 g) was added, and the product was filtered through a 100 μm filter to give an aqueous dispersion of copolymers with the following properties:
Specific gravity: 1.02;
Glass transition temperature: −41.9° C.;
Solids content: 41.4 wt %;
Total remaining free monomer: <300 ppm;
Z-average particle size immediately after preparation: 129 nm (PDI=0.10);
Z-average particle size measured after letting stand at 25° C. for 840 days: 117 nm (PDI=0.02); Viscosity (Brookfield): 18.3 mPa·s)
Stability: The dispersion is stable against any visible separation for >720 days at 25° C.
VOC: 1.1 wt %
   When the aqueous dispersion of copolymers was applied to a substrate and cured into a film, the adhesive composition had the following properties:
Peak tack: 492±36.6 gf
180° peel stress: 1299±100.6 mN/mm (33.0±2.6 N/in)
Shear strength: 4.3±1.1 min
Water contact angle: 120.8±0.5°
   The adhesive composition of Example 1 could be utilized as a PSA.

### Example 2: Preparation of an Aqueous Dispersion of Copolymers from a Linear Methacryloxypropyl-Terminated Polydimethylsiloxane (1:9 Silicone: Organic Acrylic Monomers)

### Step 1: Preparation of Miniemulsion:

A linear methacryloxypropyl-terminated polydimethylsiloxane containing approximately 333 siloxane units was used as the silicone component.

The following components were added to a sealable vessel and mixed on an orbital shaker:

| | Weight |
|---|---|
| Component | (g) |
| Methacryloxypropyl-terminated | 77.6 |
| polydimethylsixoane | |
| 2-Ethylhexyl acrylate | 456.8 |
| Methyl acrylate | 249.4 |
| Acrylic acid | 14.0 |
| Hexadecane | 2.4 |

The resulting mixture is combined with a solution of the following components and mixed on an orbital shaker for approximately 1 hour:

| Component | Weight (grams) |
|---|---|
| Polymerizable surfactant Hitenol KH-10 | 25.00 |
| Hydroquinone monomethylether (2% solution | 3.70 |
| in water) | |
| Reverse osmosis water | 428.7 |

The pre-emulsion is passed through an IKA® HPH 2000/5 high pressure homogenizer at a pressure of 400-800 bar to obtain a miniemulsion with a z-average particle size of 405 nm (PDI=0.5).

### Step 2: Polymerization

A 3 liter polymerization vessel, equipped with an anchor stirrer, a reflux condenser, a thermometer, and a nitrogen inlet, was charged with 250 grams of reverse osmosis water, and 72 grams of the miniemulsion prepared in Step 1 as the initial charge and heated to 50° C. with stirring. In a sealable vessel, 6.61 grams of 70 wt % strength aqueous solution of tert-butyl hydroperoxide (TBHP) diluted with 39.56 grams deionized water (feed 1) was provided. In another sealable vessel, a solution of 2.32 grams of a formaldehyde-free reducing agent (Bruggolite® FF6 M) in 44.93 grams of reverse osmosis water (feed 2) was provided. In a third vessel, 828 grams of the miniemulsion (feed 3) was provided. Feeds 1 and 2 were started at a rate of 220 μL/min, followed by the start of feed 3 at a rate of 5.0 mL/min to be continuously metered over a period of 165 minutes. Feeds 1 and 2 are continued for an additional 30 minutes after the completion of feed 3, and the reaction was then held at 50° C. for an additional 60 minutes. After cooling to room temperature, the product was adjusted to a pH of 8 by the addition of aqueous ammonia. Biocide (Acticide BW 20, 0.25 g) was added, and the product was filtered through a 100 μm filter to give an aqueous dispersion of copolymers with the following properties:
Specific gravity: 1.03;
Glass transition temperature: −48.3° C.;
Solids content: 47.9 wt %;
Total remaining free monomer: 3300 ppm
Z-average particle size: 126 nm (PDI=0.11)
Z-average particle size measured after letting stand at 25° C. for 860 days: 114 nm (PDI=0.13)
Viscosity: 440 mPa·s
Stability: The dispersion is stable against any visible separation for >720 days at 25° C.
VOC: 1.6 wt %
   When the aqueous dispersion of copolymers was applied to a substrate and cured into a film, the adhesive composition had the following properties:
Peak tack: 651±254 gf
180° peel stress: 522.8±93.23 mN/mm (13.3±2.4 N/in)
Shear strength: 28.8±6.1 min
Water contact angle: 114.9±2.3°
   The adhesive composition of Example 2 could be utilized as a PSA.

### Example 3: Preparation of an Aqueous Dispersion of Copolymers from Silicone Resin B1 and Organic Acrylic Monomers (1:9 Silicone: Organic Acrylic Monomers with a Slightly Higher Amount of Polymerizable Surfactant)

### Step 1: Preparation of Miniemulsion:

The following components are added to a sealable vessel and mixed on an orbital shaker:

| | Weight |
|---|---|
| Component | (grams) |
| Resin B1 solution containing | 104.7 |
| 25% butyl acrylate | |
| 2-Ethylhexyl acrylate | 459.9 |
| Methyl acrylate | 207.1 |
| Acrylic acid | 14.3 |
| Hexadecane | 2.4 |

The resulting mixture is combined with a solution of the following components and mixed on an orbital shaker for approximately 1 hour:

| | Weight |
|---|---|
| Component | (grams) |
| Polymerizable surfactant Hitenol | 38.00 |
| KH-10 | |
| Hydroquinone monomethylether | 3.70 |
| (2% solution in water) | |
| Reverse osmosis water | 433.7 |

The pre-emulsion is passed through an IKA® HPH 2000/5 high pressure homogenizer at a pressure of 400-800 bar to obtain a miniemulsion with a z-average particle size of 272 nm (PDI=0.3).

### Step 2: Polymerization

A 3 liter polymerization vessel, equipped with an anchor stirrer, a reflux condenser, a thermometer, and a nitrogen inlet, was charged with 250 grams of reverse osmosis water, and 75 grams of the miniemulsion prepared in Step 1 as the initial charge and heated to 50° C. with stirring. In one sealable vessel, 6.61 grams of 70 wt % strength aqueous solution of tert-butyl hydroperoxide (TBHP) diluted with 39.54 g deionized water (feed 1) was provided. In a second sealable vessel, a solution of 2.37 grams of a formaldehyde-free reducing agent (Bruggolite® FF6 M) in 44.94 grams of reverse osmosis water (feed 2) was provided. In a third vessel, 825 grams of the miniemulsion (feed 3) was provided. Feeds 1 and 2 were started at a rate of 220 L/min, followed by the start of feed 3 at a rate of 5.0 mL/min to be continuously metered over a period of 165 minutes. Feeds 1 and 2 were continued for an additional 30 minutes after the completion of feed 3, and the reaction was then held at 50° C. for an additional 60 minutes. After cooling to room temperature, the product is adjusted to a pH of 8 by the addition of aqueous ammonia. Biocide (Acticide BW 20, 0.24 grams) was added, and the product was filtered through a 100 μm filter to give an aqueous dispersion with the following properties:
Specific gravity: 1.02;
Glass transition temperature: −42.2° C.;
Solids content: 46.5 wt %;
Total remaining free monomer: 4050 ppm
Z-average particle size: 132 nm (PDI=0.11)
Viscosity: 167 mPa·s
Stability: The dispersion is stable against any visible separation for >720 days at 25° C.
VOC: 1.9 wt %
   When the aqueous dispersion of copolymer was applied to a substrate and cured into a film, the adhesive composition had the following properties:
Peak tack: 989±23.7 gf
180° peel stress: 1646±63.25 mN/mm (41.8±1.6 N/in)
Shear strength: 8.3±2.5 min
Water contact angle: 119.9±1.0° Moisture vapor transmission rate: 780 g/m²/day
   The adhesive composition of Example 3 could be utilized as a PSA.

### Example 4: Preparation of an Aqueous Dispersion of Copolymers from Silicone Resin B1 and Organic Acrylic Monomers (1:1 Silicone: Organic Acrylic Monomers)

### Step 1: Preparation of Miniemulsion:

The following components are added to a sealable vessel and mixed on an orbital shaker:

| | Weight |
|---|---|
| Component | (grams) |
| Resin B1 solution containing | 497.40 |
| 25% butyl acrylate | |
| 2-Ethylhexyl acrylate | 162.12 |
| Methyl acrylate | 73.20 |
| Acrylic acid | 13.44 |
| Hexadecane | 2.28 |

The resulting mixture is combined with a solution of the following components and mixed on an orbital shaker for approximately 1 h:

| | Weight |
|---|---|
| Component | (grams) |
| Polymerizable surfactant Hitenol | 36.12 |
| KH-10 | |
| Butylated hydroxytoluene | 3.48 |
| (3.55% solution in water) | |
| Reverse osmosis water | 411.96 |

The pre-emulsion was passed through an IKA® HPH 2000/5 high pressure homogenizer at a pressure of 400-800 bar to obtain a miniemulsion with a z-average particle size of 227 nm (PDI=0.2).

### Step 2: Polymerization

A 3 liter polymerization vessel, equipped with an anchor stirrer, a reflux condenser, a thermometer, and a nitrogen inlet, was charged with 241.3 grams of reverse osmosis water, and 69.5 grams of the miniemulsion prepared in Step 1 as the initial charge and heated to 50° C. with stirring. In one sealable vessel, 6.36 grams of 70 wt % strength aqueous solution of tert-butyl hydroperoxide (TBHP) diluted with 38.16 grams deionized water (feed 1) was provided. In a second sealable vessel, a solution of 2.28 grams of a formaldehyde-free reducing agent (Bruggolite® FF6 M) in 43.32 grams of reverse osmosis water (feed 2) was provided. In a third vessel, 799 grams of the miniemulsion (feed 3) was provided. Feeds 1 and 2 were started at a rate of 220 μL/min, followed by the start of feed 3 at a rate of 5.0 mL/min to be continuously metered over a period of 165 minutes. Feeds 1 and 2 are continued for an additional 30 minutes after the completion of feed 3, and the reaction was held at 50° C. for an additional 60 minutes. After cooling to room temperature, the product is adjusted to a pH of 8 by the addition of aqueous ammonia. Biocide (Acticide BW 20, 0.24 g) was added, and the product is filtered through a 100 μm filter to give a dispersion with the following properties:
Specific gravity: 1.04;
Glass transition temperature: −40.3° C.;
Solids content: 45.9 wt %;
Total remaining free monomer: 1381 ppm
Z-average particle size: 182 nm (PDI=0.19)
Viscosity: 17 mPa·s
VOC: 1.51 wt %
   When the aqueous dispersion of copolymer was applied to a substrate and cured into a film, the adhesive composition had the following properties:
Peak tack (381 microns wet thickness): 289±49 gf
180° peel stress: 815 mN/mm (20.7 N/in)
Moisture vapor transmission rate: 790 g/m²/day
   The adhesive composition of Example 4 could be utilized as a PSA.

### Example 5: Preparation of an Aqueous Dispersion of Copolymers from Methacryloxypropyltris(Trimethylsiloxysilane and Organic Acrylic Monomers (7:3 Silane: Organic Acrylic Monomers)

### Step 1: Preparation of Miniemulsion:

The following components are added to a sealable vessel and mixed on an orbital shaker:

| | Weight |
|---|---|
| Component | (grams) |
| Methacryloxypropyltris(trimethylsiloxysilane) | 405.95 |
| 2-Ethylhexyl acrylate | 115.92 |
| Methyl acrylate | 40.57 |
| Acrylic acid | 17.44 |
| Hexadecane | 1.77 |

The resulting mixture is combined with a solution of the following components and mixed on an orbital shaker for approximately 1 hour:

| | Weight |
|---|---|
| Component | (grams) |
| Polymerizable surfactant Hitenol | 28.07 |
| KH-10 | |
| Hydroquinone Monomethylether | 2.70 |
| (2% solution in water) | |
| Reverse osmosis water | 320.15 |

The pre-emulsion is passed through an IKA® HPH 2000/5 high pressure homogenizer at a pressure of 400-800 bar to obtain a miniemulsion with a z-average particle size of 936.5 nm (PDI=0.3).

### Step 2: Polymerization

A 3 L polymerization vessel, equipped with an anchor stirrer, a reflux condenser, a thermometer, and a nitrogen inlet, was charged with 201.10 grams of reverse osmosis water, and 57.90 grams of the miniemulsion prepared in Step 1 as the initial charge and heated to 50° C. with stirring. In one sealable vessel, a 5.30 grams of 70 wt % strength aqueous solution of tert-butyl hydroperoxide (TBHP) was diluted with 31.80 grams deionized water (feed 1). In a second sealable vessel, a solution of 1.90 grams of a formaldehyde-free reducing agent (Bruggolite® FF6 M) in 36.10 grams of reverse osmosis water was prepared (feed 2). In a third vessel was placed 665.90 grams of the miniemulsion (feed 3). Feed 1 and 2 were started at a rate of 220 μL/min, followed by the start of feed 3 at a rate of 5.0 mL/min to be continuously metered over a period of 165 minutes. Feeds 1 and 2 were continued for an additional 30 minutes after the completion of feed 3, and the reaction was then held at 50° C. for 60 minutes further. After cooling to room temperature, the product was adjusted to a pH of 8 by the addition of aqueous ammonia. Biocide (Acticide BW 20, 0.20 grams) was added, and the product was filtered through a 100 μm filter to give a dispersion with the following properties:
Specific gravity: 1.00
Glass transition temperature: −47.6° C.
Solids content: 49.8 wt %
Total remaining free monomer: 2961 ppm
Z-average particle size: 269 nm (PDI=0.0.4)
Viscosity: 126 mPa·s
VOC: 1.46 wt %
   When the aqueous dispersion of copolymer was applied to a substrate and cured into a film, the adhesive composition had the following properties:
Peak tack: 809±168.9 gf
180° peel stress: 886 mN/mm (22.5 N/in)
Moisture vapor transmission rate: 1160 g/m²/day
   The adhesive composition of Example 5 could be utilized as a PSA.

### Example 6 Preparation of an Aqueous Dispersion of Copolymers from Silicone Resin B1, Methacryloxypropyltris(Trimethylsiloxysilane, and Organic Acrylic Monomers (14:1 (Silicone+Silane):Organic Acrylic Monomers)

### Step 1: Preparation of Miniemulsion:

The following components are added to a sealable vessel and mixed on an orbital shaker:

| | Weight |
|---|---|
| Component | (grams) |
| Methacryloxypropyltris (trimethylsiloxysilane) | 300.00 |
| Resin B1 solution containing 25% butyl | 109.14 |
| acrylate | |
| Hexadecane | 1.25 |

The resulting mixture is combined with a solution of the following components and mixed on an orbital shaker for approximately 1 hour:

| | Weight |
|---|---|
| Component | (grams) |
| Polymerizable surfactant Hitenol | 19.81 |
| KH-10 | |
| Hydroquinone Monomethylether | 1.91 |
| (2% solution in water) | |
| Reverse osmosis water | 225.89 |

The pre-emulsion is passed through an IKA® HPH 2000/5 high pressure homogenizer at a pressure of 400-800 bar to obtain a miniemulsion with a z-average particle size of 296 nm (PDI=0.3).

### Step 2: Polymerization

A 1 liter polymerization vessel, equipped with an anchor stirrer, a reflux condenser, a thermometer, and a nitrogen inlet, is charged with 152.81 grams of reverse osmosis water, and 44.00 grams of the miniemulsion prepared in Step 1 as the initial charge and heated to 50° C. with stirring. In one sealable vessel, 1.35 grams of 70 wt % strength aqueous solution of tert-butyl hydroperoxide (TBHP) was diluted with 25.36 grams deionized water (feed 1) was provided. In a second sealable vessel, a solution of 0.47 grams of a formaldehyde-free reducing agent (Bruggolite® FF6 M) in 26.23 g of reverse osmosis water (feed 2) was provided. In a third vessel 506.00 grams of the miniemulsion (feed 3) was provided. Feeds 1 and 2 were started at a rate of 220 μL/min, followed by the start of feed 3 at a rate of 5.0 mL/min to be continuously metered over a period of 165 minutes. Feeds 1 and 2 are continued for an additional 30 minutes after the completion of feed 3, and the reaction was then held at 50° C. for an additional 60 minutes. After cooling to room temperature, the product was adjusted to a pH of 8 by the addition of aqueous ammonia. Biocide (Acticide BW 20, 0.15 grams) was added, and the product is filtered through a 100 μm filter to give a dispersion with the following properties:
Specific gravity: 1.01
Glass transition temperature: −59.0° C.
Solids content: 47.4 wt %
Total remaining free monomer: 2740 ppm
Z-average particle size: 292 nm (PDI=0.4)
Viscosity: 50 mPa·s
VOC: 1.37 wt %
   When the aqueous dispersion of copolymer was applied to a substrate and cured into a film, the
adhesive composition had the following properties:

Peak tack (1 wt % wetting agent WACKER® L067 was blended with the dispersion before film
drawdown): 510±50 gf
180° peel stress (1 wt % wetting agent L067 was used for film drawdown): 91 mN/mm (2.3 N/in)
   Moisture vapor transmission rate: 820 g/m²/day
   The adhesive composition of Example 6 could be utilized as a PSA.

### Example 7: Release of Melatonin

The controlled release of melatonin, reported as cumulative flux Q (μg/cm²) against the inverse of time (min^{1/2}), from a copolymer sample was determined by adding melatonin to a copolymer dispersion (Example 4, RH47). The sample was prepared by mixing 0.069 g of melatonin with 10.000 g of copolymer dispersion (approximately 1.5 wt % melatonin in solids content). A film was formed from the mixture. The film had a thickness of 381 microns after being drawn on a corona treated MYLAR™ sheet with a film applicator and cured in an oven at 80° C. for 10 min. After forming the film, the tack exhibited by the film was measured at 248 gf.

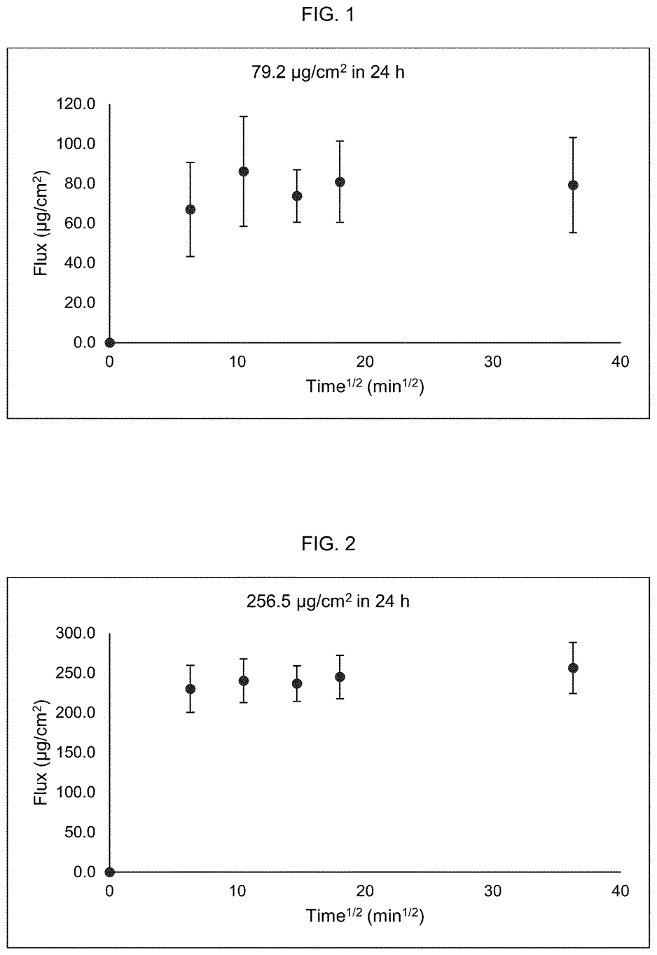

To measure the release of melatonin from the film, the sample was mounted on a Franz cell. As illustrated in FIG. 1, the release of melatonin from the sample was measured at 79.2 μg/cm² after 24 hours. The release profile shown in FIG. 1 indicates controlled release of melatonin as evident with the positive correlation between the release with the inverse of time.

### Example 8: Release of Niacinamide

The controlled release of niacinamide, reported as cumulative flux Q (μg/cm²) against the inverse of time (min^{1/2}), from a copolymer sample was determined by adding niacinamide to a copolymer dispersion (Example 4, RH47). The sample was prepared by mixing 0.237 grams of niacinamide with 10.00 grams of copolymer dispersion (approximately 5.0 wt % melatonin in solids content). A film was formed from the mixture. The film had a thickness of 381 microns after being drawn on a corona treated MYLAR™ sheet with a film applicator and cured in an oven at 80° C. for 10 min. After forming the film, the tack exhibited by the film was measured at 825 gf.

To measure the release of niacinamide from the sample, the sample was mounted on a Franz cell. As illustrated in FIG. 2, the release of niacinamide from the sample was measured at 256.5 μg/cm² after 24 hours. The release profile shown in FIG. 2 indicates controlled release of niacinamide as evident with the positive correlation between the release with the inverse of time.

### Example 9: Transfer-Coating of Adhesive Composition

The aqueous dispersion of copolymers from Example 5 was mixed with a wetting agent, WACKER Fluid L067 (1% by weight of the PSA dispersion). Adhesive films having a wet film thickness of 127 microns were formed on strips of 3M™ Medical Release Liner 9955 (fluoropolymer coated polypropylene) and cured in an oven at 60° C. for 15 minutes. The resulting adhesive-coated strips were then applied to substrates (facestocks) of interest (stainless-steel, aluminum, Mylar®, polyurethane), with pressure applied using a 5 lb-weighted rubber roller in four strokes (two sets of back-and-forth strokes). After a dwell time of five minutes, the adhesive-coated strips were removed from the substrates. The adhesive films transferred to the substrates, and a continuous adhesive film of approximately 25.4 to 38.1 micron thickness was obtained on each substrate.

### Comparative Example 1: Solvent-Based Silicone-Acrylic Hybrid Adhesive Prepared from Silicone Resin B1 and Organic Acrylic Monomers

A 250 mL 4-necked round-bottom flask, equipped with an anchor stirrer, a reflux condenser, a thermometer, and a nitrogen inlet, was charged with the following components:

| | Weight |
|---|---|
| Component | (grams) |
| Ethyl acetate | 121.02 |
| 2-Ethylhexyl acrylate (EHA) | 32.41 |
| Methyl acrylate | 14.61 |
| Resin B1 solution containing | 7.41 |
| 25% butyl acrylate | |

The components were stirred together until homogeneous. A tenth of a gram of initiator azobisisobutyronitrile was added with stirring. The mixture was heated with continuous stirring under nitrogen to 70° C. After 10 minutes of stirring the reaction mixture turned into an unworkable gel.

### Comparative Example 2: Water-Borne Silicone-Acrylic Hybrid, Prepared According to US 2018/0305576 A1, without Adhesive Properties

### Step 1: Preparation of Miniemulsion

The following components are added to a sealable vessel and mixed on an orbital shaker:

| | Weight |
|---|---|
| Component | (grams) |
| Resin B1 solution containing | 589.0 |
| 25% butyl acrylate | |
| Butyl acrylate | 890.0 |
| Methyl methacrylate | 756.9 |
| Butyl methacrylate (BMA) | 331.0 |
| styrene | 188.4 |
| Methacrylic acid (MAA) | 52.3 |
| Hexadecane | 19.4 |

The resulting mixture is combined with a solution of the following components and mixed on an orbital shaker for approximately 1 hour:

| | Weight |
|---|---|
| Component | (grams) |
| sodium dodecyl sulfate | 84.6 |
| Hydroquinone Monomethylether | 13.1 |
| (2% solution in water) | |
| Deionized water | 1576.4 |

The pre-emulsion is passed through an IKA® HPH 2000/5 high pressure homogenizer at a pressure of 400-800 bar to obtain a miniemulsion with a z-average particle size of 185.3 nm (PDI=0.2).

### Step 2: Polymerization

A 10 liter polymerization vessel, equipped with an anchor stirrer, a reflux condenser, a thermometer, and a nitrogen inlet, is charged with 1278 grams of reverse osmosis water, and 320 grams of the miniemulsion prepared in Step 1 as the initial charge and heated to 50° C. with stirring. In one sealable vessel, 29.32 grams of 70 wt % strength aqueous solution of tert-butyl hydroperoxide (TBHP) diluted with 96.65 grams deionized water (feed 1) was provided. In a second sealable vessel, a solution of 10.28 grams of a formaldehyde-free reducing agent (Bruggolite® FF6 M) in 107.21 grams of reverse osmosis water (feed 2) was prepared. In a third vessel, 3976.3 grams of the miniemulsion (feed 3) was prepared. Feeds 1 and 2 were started, followed by the start of feed 3, to be continuously metered over a period of 165 minutes. Feeds 1 and 2 were continued for an additional 30 minutes after the completion of feed 3, and the reaction was then held at 50° C. for an additional 60 minutes. After cooling to room temperature, the product was adjusted to a pH of 6.5 by the addition of aqueous ammonia. Biocide (Acticide BW 20, 1.11 grams) was added, and the product was filtered through a 100 μm filter to give a dispersion with the following properties:
Specific gravity: 1.05;
Glass transition temperature: 13.7° C.;
Solids content: 45.8%;
Total remaining free monomer: 1768 ppm
Z-average particle size: 119.5 nm (PDI=0.19)
   A film drawn from the copolymer dispersion showed no tack after curing.

From the foregoing detailed description, it will be apparent that various modifications, additions, and other alternative embodiments are possible without departing from the true scope and spirit. The embodiments and examples discussed herein were chosen and described to provide the best illustration of the principles of the invention and its practical application to thereby enable one of ordinary skill in the art to use the invention in various embodiments and with various modifications as are suited to the particular use contemplated. As should be appreciated, all such modifications and variations are within the scope of the invention.

1-20. (canceled)

21. A process for forming an aqueous dispersion of copolymers, comprising:
providing a copolymerizable composition in water, the copolymerizable composition including
a) 5 to 95% by weight of ethylenically functionalized silicone polymers or silanes, which is based on the total weight of the copolymerizable composition, and
b) 5% or more by weight of organic acrylic monomers, which is based on the total weight of the copolymerizable composition;
providing 0.1 to 10 wt % of a polymerizable surfactant, which is based on the total weight of the ethylenically functionalized silicone polymers or silanes and organic acrylic monomers;
forming a miniemulsion comprising organic droplets, wherein the organic droplets comprise the ethylenically functionalized silicone polymers or silanes, organic acrylic monomers, and polymerizable surfactant;
polymerizing the ethylenically functionalized silicone polymers or silanes and the organic acrylic monomers, in the presence of the polymerizable surfactant and water, to form an aqueous dispersion of copolymers,
wherein the aqueous dispersion of copolymers comprises a solids content of 40 wt % or more, based on the total weight of the aqueous dispersion, and the copolymers exhibit a glass transition temperature (Tg) of 0 to −100° C., the Tg being determined by differential scanning calorimetry with a heating rate of 10° K per minute according to DIN 53765, pierced crucible.

22. The process of claim 21, further comprising introducing an initiator, and wherein the organic acrylic monomers comprise acrylic or methacrylic acids and esters.

23. The process of claim 21, wherein the organic droplets are formed prior to polymerizing the ethylenically functionalized silicone polymers or silanes and the organic acrylic monomers.

24. The process of claim 21, further comprising curing the aqueous dispersion of copolymers by heating the aqueous dispersion to evaporate the water therefrom.

25. The process of claim 21, wherein the aqueous dispersion of copolymers comprises a solids content of 40 to 70 wt %, based on the total weight of the aqueous dispersion.

26. The process of claim 21, wherein the copolymers exhibit a Tg of −10 to −60° C.

27. The process of claim 21, wherein the copolymers have a z-average particle size of 1000 nanometers or less when measured by a dynamic light scattering method.

28. The process of claim 21, wherein the aqueous dispersion of copolymers exhibits a viscosity of 1 to 20,000 mPa·s at 25° C., determined by measurement using rotational viscometry in accordance with DIN EN ISO 3219 by using a Brookfield viscometer [spindle LV 1, 10 rpm].

29. An adhesive composition, comprising:
the copolymers formed by the process of claim 21, wherein the copolymers comprise a polymerizable surfactant and the organic acrylic monomers are acrylic or methacrylic acids and esters, wherein a film of the adhesive composition having a 381 microns wet thickness exhibits a peak tack of 100 grams of force or more after curing when measured a TA.XT Plus Texture Analyzer using a TA-57R probe and a TA-303 apparatus.

30. The adhesive composition of claim 29, further comprising an active compound that can be released at a controlled rate from a matrix formed by the copolymers.

31. The adhesive composition of claim 29, wherein the adhesive composition is stable against layer separation at 25° C. as measured by the absence of any observable phase separation for 180 days.

32. The adhesive composition of claim 29, wherein the adhesive composition has volatile organic content of 2.5% or less according to EPA test method 24.

33. The adhesive composition of claim 29, wherein the film exhibits a peak tack of 100 to 1,000 grams of force.

34. The adhesive composition of claim 29, wherein the composition is stable against layer separation at 25° C. as measured by the absence of variation in z-average particle size by more than 20%.

35. The adhesive composition of claim 29, wherein the adhesive composition is a pressure sensitive adhesive.

36. A film comprising the adhesive composition of claim 29 which exhibits a peak tack of 100 to 1,000 grams of force and does not leave a deposit upon contact therewith.

37. An article, comprising:
the adhesive composition of claim 29; and
a substrate that has the adhesive composition provided thereon, wherein the adhesive composition forms a film on the polymeric substate, the film has a 381 microns wet thickness and, after curing at 60° C. for 15 minutes, attaching a stainless steel plate to an outer surface of the film, resting for 30 minutes and then removing the stainless plate at a rate of 300 mm/min (12 in/min), the film exhibits a 180 degree peel strength of 0.059 N/mm (1.5 N/inch) or more as measured by an adhesion/release tester at a rate of 300 mm/min (12 in/min).

38. A method of coating a substrate, comprising:
applying the adhesive composition of claim 29 to a substrate; and
curing the composition.

39. The method of claim 38, wherein the adhesive composition is applied by spraying, knife coating, roller coating, casting, drum coating, dipping and combinations thereof or by a transfer-coating method.
